(19) United States
(12) Patent Application Publication
(10) Pub. No.: US 2025/0226866 A1
(43) Pub. Date: Jul. 10, 2025

(54) METHODS AND APPARATUS FOR WTRU-SPECIFIC CHANNEL STATE INFORMATION CODEBOOK DESIGN

(71) Applicant: InterDigital Patent Holdings, Inc., Wilmington, DE (US)

(72) Inventors: Onur Sahin, London (GB); Yugeswar Deenoo Narayanan Thangaraj, Chalfont, PA (US); Mohamed Salah Ibrahim, Chesterbrook, PA (US); Arman Shojaeifard, London (GB); Arnab Roy, Phoenixville, PA (US); Moon-il Lee, Melville, NY (US)

(21) Appl. No.: 18/853,485

(22) PCT Filed: Apr. 5, 2023
(86) PCT No.: PCT/US2023/017619

§ 371 Date: Oct. 2, 2024

Related U.S. Application Data
(60) Provisional application No. 63/327,549, filed on Apr. 5, 2022.

(51) Int. Cl. H04B 7/06

(52) U.S. Cl. CPC H04B 7/0626; H04B 7/0639

(57) ABSTRACT

Procedures, methods, architectures, apparatuses, systems, devices, and computer program products directed, in part, to WTRU-specific codebooks generated based on channel state information (CSI) measurements and channel and/or transmission details, parameters and/or requirements. As an example, a WTRU may receive information indicating any of metrics and requirements for configuring a codebook; generate a codebook, comprising first parameters, based on the metrics and CSI related measurements associated with at least a first set of subbands, wherein the first parameters comprise a cluster of subbands having a CSI correlation satisfying a threshold and comprising at least one subband from any of the first set of subbands and a second set of subbands that is based on the first set of subbands; and transmit feedback information associated with CSI, the feedback information indicating at least some of the first parameters and second parameters associated with the at least some of the first parameters.

### CROSS REFERENCE TO RELATED APPLICATIONS

This application claims the benefit of U.S. Provisional Patent Application No. 63/327,549 filed Apr. 5, 2022, which is incorporated herein by reference.

### BACKGROUND

This application is related to wired and/or wireless communications, including, for example, methods, apparatus, systems, and techniques for providing WTRU-specific channel state information precoding codebooks, such as for carrying out WTRU-specific precoding codebook generation and/or providing feedback and/or information associated with generated WTRU-specific precoding codebooks.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“Figs”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is diagram illustrating an example of a configuration for CSI reporting settings, resource settings, and links;

FIG. 3 is a diagram illustrating codebook-based precoding with feedback information;

FIG. 4 is a graphical representation of a W1 codebook in accordance with an embodiment; and

FIGS. 5-12 are flow charts illustrating example flows for carrying out WTRU-specific codebook generation and/or providing information associated with the generated WTRU-specific codebook.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications Systems

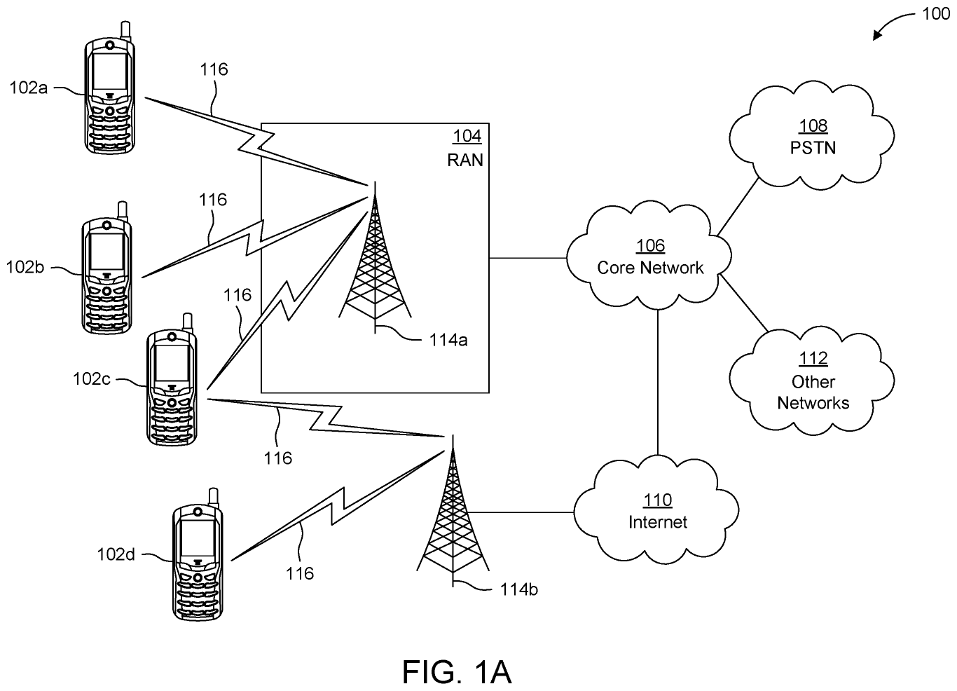

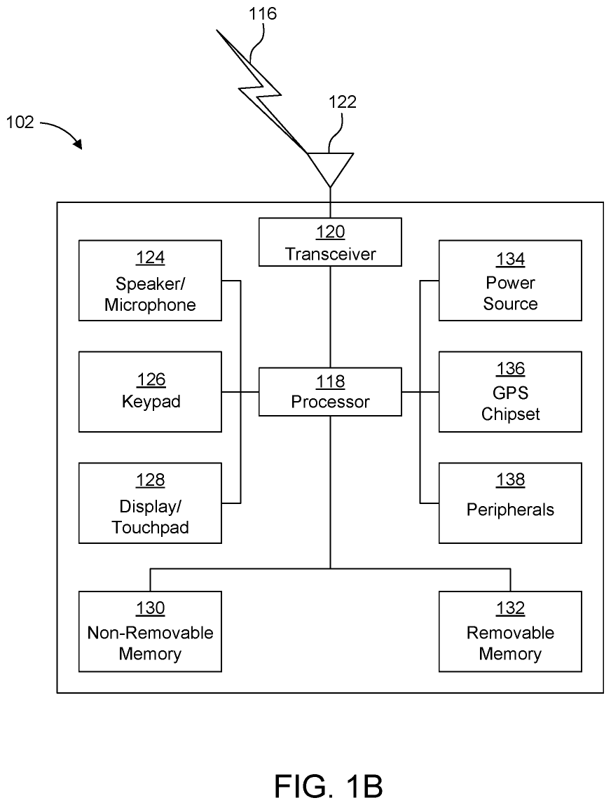

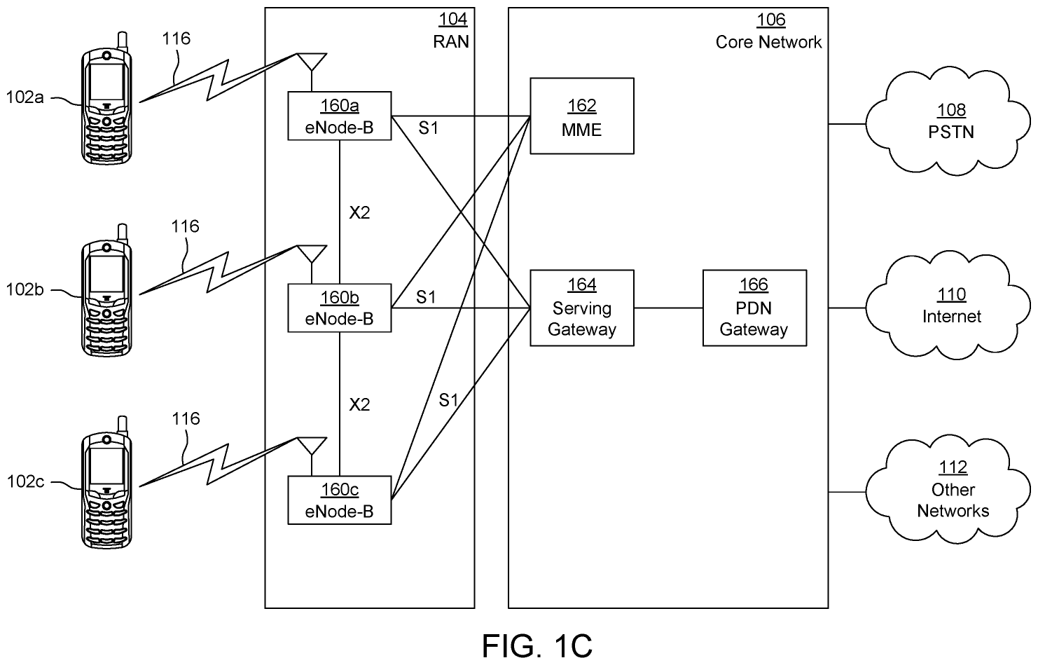

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encoded B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11 af and 802.11 ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

The following description is for exemplary purposes and does not limit in any way the applicability of the methods, techniques, apparatus, and systems described herein to a specific wireless technology, to a specific communication technology and/or to other technologies, when applicable. The term “network” in this disclosure may refer to one or more gNBs which in turn may be associated with one or more transmission/reception points (TRPs), or to any other physical and/or logical node in the radio access network.

### Artificial Intelligence

Artificial intelligence (AI) may be broadly defined as the behavior exhibited by machines. Such behavior may, e.g., mimic cognitive functions to sense, reason, adapt, and act.

### Machine Learning

Machine learning may refer to the types of algorithms that solve a problem based on learning through experience (“data”), without explicitly being programmed (“configured set of rules”). Machine learning (ML) may be considered a subset of AI, and AI and ML may be referred to collectively as “AIML”. Different machine learning paradigms may be envisioned based on the nature of data or feedback available to the learning algorithm. For example, a supervised learning approach may involve learning a function that maps an input to an output based on labeled training examples, wherein each training example may be a pair consisting of an input and the corresponding output. For example, an unsupervised learning approach may involve detecting patterns in the data with no pre-existing labels. For example, a reinforcement learning approach may involve performing a sequence of actions in an environment to maximize the cumulative reward. In some solutions, it is possible to apply machine learning algorithms using a combination or interpolation of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data).

### Deep Learning

Deep learning refers to a class of machine learning algorithms that employ artificial neural networks (specifically deep neural networks (DNNs)), which were loosely inspired from biological systems. DNNs are a special class of machine learning models inspired by the human brain, wherein the input is linearly transformed and passed-through non-linear activation function multiple times. DNNs typically comprise multiple layers where each layer comprises a linear transformation and a given non-linear activation function. DNNs may be trained using the training data via a back-propagation algorithm. Recently, DNNs have shown state-of-the-art performance in a variety of domains, e.g., speech, vision, natural language, etc., and for various machine learning settings, such as supervised, un-supervised, and semi-supervised. The term AIML-based methods/processing may refer to realization of behaviors and/or conformance to requirements by learning based on data, without explicit configuration of sequence of steps or actions. Such methods may enable learning complex behaviors that might be difficult to specify and/or implement when using legacy methods.

### Channel State Information

Channel State Information (CSI) may include at least one of: a channel quality index (CQI), a rank indicator (RI), a precoding matrix index (PMI), a layer 1 (L1) channel measurement (e.g., reference signal received power (RSRP), such as L1 reference signal received power (L1-RSRP) or signal to interference and noise ratio (SINR)), a CSI reference signal (CSI-RS) resource indicator (CRI), a synchronization signal/physical broadcast channel (SS/PBCH) block resource indicator (SSBRI), layer indicator (LI) and/or any other measurement quantity measured by the WTRU from the configured reference signals (e.g. CSI-RS or SS/PBCH block or any other reference signal).

### CSI Reporting Framework

A WTRU may be configured to report the CSI through an uplink control channel on the physical uplink control channel (PUCCH), or per a gNB's request on an uplink physical shared channel (PUSCH) grant. Depending on the configuration, a CSI-RS may cover the full bandwidth of a bandwidth part (BWP) or a fraction of it. Within the CSI-RS bandwidth, a CSI-RS may be configured in each physical resource block (PRB) or every other PRB. In the time domain, CSI-RS resources may be configured periodically, semi-persistently, or aperiodically. Semi-persistent CSI-RS is similar to periodic CSI-RS, except that the resource can be (de)-activated by MAC CEs; and the WTRU reports related measurements only when the resource is activated. For aperiodic CSI-RS, the WTRU is triggered to report measured CSI-RS on PUSCH by request in a downlink control information (DCI). Periodic reports are carried over the PUCCH, while semi-persistent reports may be carried either on PUCCH or PUSCH. The reported CSI may be used by the scheduler in determining optimal resource block allocations (possibly based on a channel's time-frequency selectivity), determining precoding matrices, determining beams, determining transmission mode, and/or selecting suitable modulation and coding schemes (MCSs). The reliability, accuracy, and timeliness of WTRU CSI reports may be critical for meeting service requirements for ultra reliable and low latency communications (URLLC).

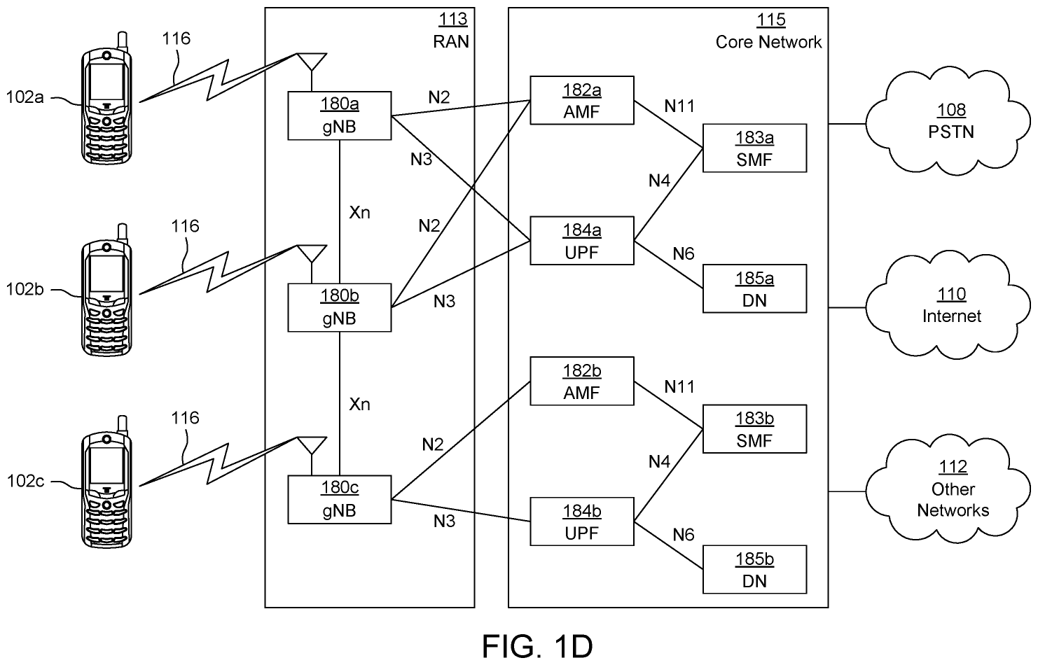

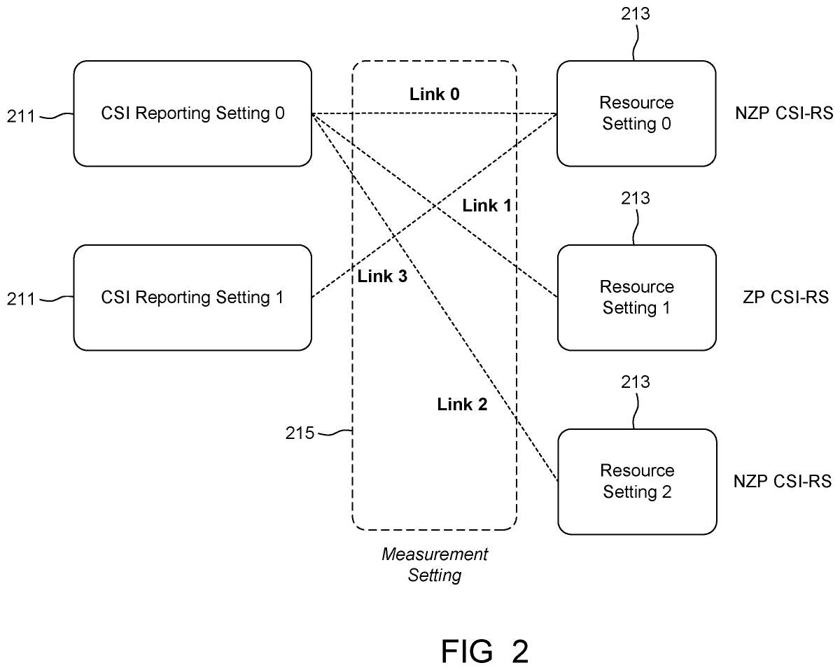

A WTRU may be configured with CSI configuration which may include one or more CSI reporting settings, resource settings, and/or a link between one or more CSI reporting settings and one or more resource settings. The link may be achieved, for instance, by providing pointers to resource configurations within the CSI reporting settings. FIG. 2 shows an example of a configuration for CSI reporting settings, resource settings, and links, as disclosed in more detail below.

In a CSI configuration, one or more of the following configuration parameters may be provided: (i) N≥1 CSI reporting settings 211, (ii) M≥1 resource settings 213, and (iii) linkages between the N CSI reporting settings 211 with the M resource settings 213. The CSI reporting setting 211 may include at least one of: (i) time-domain behavior: aperiodic or periodic/semi-persistent; (ii) frequency granularity, at least for PMI and CQI; (iii) a CSI reporting type (e.g., PMI, CQI, RI, CRI, etc.); and (iv) PMI type (Type I or II) and codebook configuration, if a PMI is reported.

The resource setting 213 may include at least one of: (i) time-domain behavior: aperiodic or periodic/semi-persistent; (ii) a RS type (e.g., for channel measurement or interference measurement); and (iii) S≥1 resource set(s), wherein each resource set may contain K resources, where K is an integer that may be preconfigured.

For CSI reporting for a component carrier, one or more of the following frequency granularities may be supported: (i) wideband CSI, (ii) partial band CSI, and (iii) subband CSI.

### Codebook-Based Precoding

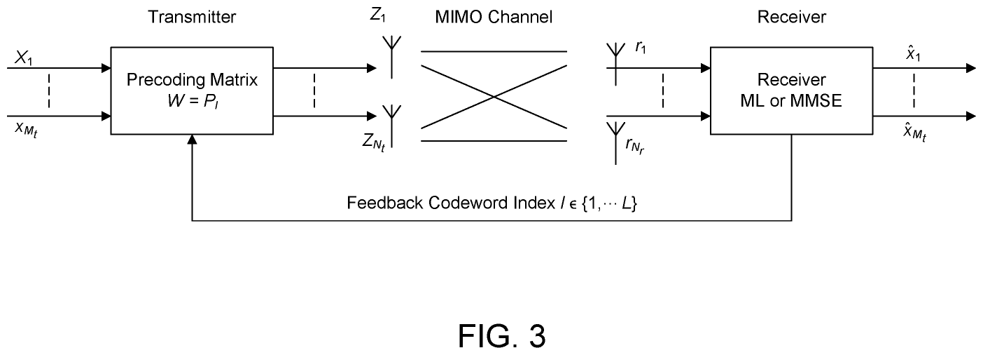

FIG. 3 shows a basic concept of codebook-based precoding with feedback information. The feedback information may include a PMI, which may be referred to as a codeword index in the codebook, as shown in FIG. 3.

As shown in FIG. 3, a codebook includes a set of precoding vectors/matrices for each rank and a number of antenna ports, and each precoding vector/matrix has its own index so that a receiver may inform the transmitter of a preferred precoding vector/matrix index. Codebook-based precoding may suffer performance degradation due to its finite number of precoding vectors/matrices as compared with non-codebook-based precoding. However, a major advantage of codebook-based precoding is the possibility of lower control signaling/feedback overhead. Table 1 shows an example of a codebook for 2Tx.

TABLE 1
2Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

In 5G NR, two types of CSI feedback are defined, namely Type I CSI and Type II CSI. Type I CSI typically includes lower granularity regarding the CSI and is used in single user transmissions, i.e., single user MIMO (SU-MIMO). Type II CSI, on the other hand, is composed of higher granularity information that is essential in multiple user MIMO (MU-MIMO) transmissions. In both Type I and Type II CSI, a W1 matrix corresponds to the wideband precoder/PMI, whereas a W2 matrix is determined per subband. W1 identifies the beams per transmission based on the over-sampled discrete Fourier transform (DFT) codebook. W2 then chooses the linear combination coefficients (LCC), which includes amplitude/power scaling per antenna, phase coefficients, and co-phasing between two polarizations per subband.

For MU-MIMO transmission, the PMI codebook is designed to represent dominant channel eigenvectors for multiple subbands with high-resolution, i.e., N×K channel matrix H_{N,K}, where K is the number of subbands, and the k-th column of H_{N,K} corresponds to the channel eigenvector for subband k. The Rel. 15 Type II CSI is based on compressing (columns of) H_{N,K} in the spatial domain by performing linear combination (LC) of L>1 spatial domain basis vectors that comprise columns of matrix W₁. In particular, an eigenvector e of the channel is expressed as a LC of L DFT vectors: e≈Σᵢ₌₀^{L-1}cᵢbᵢ. The PMI codebook is used to report the following components: (i) W₁: DFT vectors {bᵢ}ᵢ₌₀^{L-1} reported common for all subbands (wideband reporting); and (ii) W₂: amplitude and phase of coefficients {cᵢ}ᵢ₌₀^{L-1} reported independently for each subband (subband reporting).

Whilst Rel-15 Type II CSI facilitates high-resolution downlink CSI at the gNB, the associated uplink reporting overhead is prohibitively high. This overhead may be particularly burdensome on the system as high-resolution downlink CSI is typically needed for MU-MIMO (large number of users in the cell), see, e.g., Table 2 below.

TABLE 2
Rel. 15 Type II CSI Reporting Payload (bits) for 10 Subbands

| | W1 (bits) | | W2 (bits) | | Total (bits) | |
|---|---|---|---|---|---|---|
| L | Rank 1 | Rank 2 | Rank 1 | Rank 2 | Rank 1 | Rank 2 |
| 2 | 22 | 33 | 12 | 24 | 142 | 273 |
| 4 | 39 | 63 | 24 | 48 | 279 | 543 |

The Rel. 15 Type II CSI compresses (columns of) H_{N,K} in a spatial domain by performing LC using spatial domain basis matrix W₁, and there is no compression across rows of H_{N,K} in a frequency domain. The LC coefficients that combine columns of W₁ matrix is given by columns of matrix W₂=pseudo_inv(W₁)H_{N,K}=W1 H_{N,K}. It is well-known that each row of the W₂ matrix (that corresponds to K frequency domain components such as frequency subbands) comprises LC coefficients that are correlated. This correlation in frequency domain may be exploited to reduce Type II CSI payload without significant impact on throughput performance.

In the Rel. 16 enhanced Type II CSI, H_{N,K} is compressed in both spatial domain and frequency domain by performing LC using L spatial domain DFT basis vectors, i.e., columns of W₁ for spatial domain compression, and M frequency domain DFT basis vectors, i.e., columns of W_{f}=[f₀ . . . f_{M-1}] for frequency domain compression. In other words, the spatial domain compression is performed using W₁, and the resultant W₂ matrix is compressed in frequency domain using W_{f}. The 2L×M coefficient matrix after spatial domain/frequency domain compression is \tilde{W}₂=W₂W_{f}.

The PMI codebook parameterized by (L, M, K₀) is used to report the following components: (i) W₁: spatial domain DFT vectors {bᵢ}ᵢ₌₀^{L-1} reported common for all subband (wideband reporting); (ii) W_{f}: frequency domain DFT vectors {fₘ}ₘ₌₀^{M-1} reported independently for each subband (subband reporting), where M=┌p×K┐; and (iii) \tilde{W}₂. \tilde{W}₂ comprises the following components: (i) non-zero (NZ) subset selection: K₀ out of 2LM NZ coefficients of \tilde{W}₂ are selected, and the remaining 2LM−K₀ coefficients are set to 0, where K₀=┌β×2LM┐ and to ensure that the overhead is not too large, the following restriction is applied, K^{NZ}≤2K₀ and K^{NZ,l}≤K⁰, where K^{NZ,l} is a number of non-zero (NZ) coefficients for layer l and K^{NZ} is a total number of NZ coefficients across all layers; (ii) strongest coefficient: 1 out of K₀ NZ coefficients is selected and is set to 1; and (iii) quantization: amplitude and phase of remaining K₀−1 NZ coefficients {c_{i,m}} is/are reported.

Whilst Rel-16 enhanced the Rel-15 Type-II to allow improved performance-overhead trade-off, CSI enhancements designed for Type-II assuming FDD (angle-delay) reciprocity was considered in Rel-17 to support additional deployment scenarios. The Rel-17 eType-II PS codebook assumes W₁W₂W_{f}^{H} codebook structure as Rel-16. The key enhancement comes from exploiting angle-delay reciprocity in DL and UL which is applicable for both TDD and FDD. By doing so, spatial domain and frequency domain compression operation inherent in the Rel-16 eType-II PS codebook may be shifted toward the gNB, thereby reducing WTRU computational burden. While the amplitude and phase per channel/propagation path are generally not DL and UL reciprocal, the gNB may employ angle-delay information obtained from UL measurements to precode WTRU-specific CSI-RS. Therefore from the CSI measurement perspective at the WTRU, a subset of CSI-RS ports based on beamformed CSI-RS resource are first selected by the WTRU and represented by W₁, frequency domain compression is represented by W_{f} (giving rise to up to two selected DFT vectors), and, lastly, linear combination coefficients are quantized in amplitude and phase by W₂ with configurable compression factors up to 1 by removing negligible coefficients.

Type II CSI has high overhead mainly due to the structure of the high granularity and large dimension of the codebook. Type II CSI overhead (also applicable to Type I CSI) may be reduced by dynamically adapting the CSI codebook based on determination/feedback/configuration of the CSI codebook parameters or the codebook itself specific to the WTRU.

### Overview

Methods, apparatuses, systems, etc. directed to, and/or in connection with, for carrying out WTRU-specific codebook generation and/or providing information associated with the generated WTRU-specific codebook are disclosed herein. Such methods, apparatuses, systems, etc., for example, may address the involvement of (methodologies and technologies configured in, implemented in and/or carried out by) WTRU-specific codebooks and/or reporting of information associated with generated WTRU-specific codebooks.

For simplicity of exposition, the disclosure that follows is in part from a perspective of a WTRU. Those of ordinary skill in the art will recognize that much of such disclosure may be equally applicable to a network element (e.g., a base station or other RAN element), other network element and/or a network function, and hence, such modifications and variations are intended to fall within the scope of the disclosure and the appended claims.

In various embodiments, a first method may include any of: receiving, from a network, configuration information relating to processing of a CSI-RS; determining at least one cluster of subbands that have CSI correlation above a first threshold; transmitting CSI feedback information to the network, wherein the CSI feedback information indicates the at least one cluster of subbands; receiving, from the network, information indicating a CSI feedback configuration, wherein the CSI feedback configuration and/or the information indicating the CSI feedback configuration are based on the CSI feedback information; and applying the CSI feedback configuration to determine CSI and transmit at least a portion of the CSI to the network.

In various embodiments, a second method may include any of: receiving, from a network, configuration information relating to processing of a CSI-RS; determining at least one cluster of subbands that have CSI correlation above a first threshold; transmitting CSI feedback information to the network, wherein the CSI feedback information indicates the at least one cluster of subbands; receiving, from the network, information indicating a CSI feedback configuration, wherein the CSI feedback configuration and/or the information indicating the CSI feedback configuration are based on the CSI feedback information; determining CSI based on the CSI feedback configuration; and transmitting at least a portion of the CSI to the network.

In various embodiments, transmitting at least a portion of the CSI to the network may include transmitting at least a portion of the CSI to the network based on the CSI feedback configuration.

In various embodiments, any of the first and second methods may be implemented in the WTRU for generating CSI feedback information and transmitting the CSI feedback information to a network.

In various embodiments, the CSI being determined based on the CSI feedback configuration may include the CSI being determined from one or more measurements of the CSI-RS.

In various embodiments, the information indicating a CSI feedback configuration may include information indicating to use a CSI feedback configuration. In various embodiments, the information indicating a CSI feedback configuration may include any of an indication indicating the CSI feedback configuration, an indicator indicating the CSI feedback configuration, an information element indicating the CSI feedback configuration, and a field indicating the CSI feedback configuration.

In various embodiments, transmitting at least a portion of the CSI to the network may include transmitting a report to the network, wherein the report comprises the at least a portion of the CSI.

In various embodiments, the receiving, from the network, information indicating a CSI feedback configuration may include receiving, from the network, information indicating a CSI feedback configuration responsive to the CSI feedback information transmitted to the network.

In various embodiments, the configuration relating to processing of a CSI-RS may include any of a location of CSI-RS in a resource grid, subband size, a CSI correlation threshold, cluster size, feedback size, a duration of CSI-RS measurements over which a LCC range value may be updated, and scheduling information for feedback of the LCC range value.

In various embodiments, the subbands in the cluster can be non-contiguous.

In various embodiments, the CSI feedback information may include any of locations of the subbands in the cluster, size of the cluster, LCC values per cluster, LCC statistics, and a time-window in which the LCC statistics are predicted to be within a second threshold.

In various embodiments, any of the first and second methods may be implemented in a WTRU.

In various embodiments, a third method may include any of: receiving, from a network, configuration information relating to processing of a CSI-RS; determining downlink precoding and beamforming parameters based on the received configuration information; transmitting feedback to the network regarding the determined downlink precoding and beamforming parameters; receiving, from the network, information indicating a CSI feedback configuration, wherein the CSI feedback configuration and/or the information indicating the CSI feedback configuration are based on the feedback information; and applying the CSI feedback configuration to determine CSI and transmit at least a portion of the CSI to the network.

In various embodiments, a fourth method may include any of: receiving, from a network, configuration information relating to processing of a CSI-RS; determining downlink precoding and beamforming parameters based on the received configuration information; transmitting feedback to the network regarding the determined downlink precoding and beamforming parameters; receiving, from the network, information indicating a CSI feedback configuration, wherein the CSI feedback configuration and/or the information indicating the CSI feedback configuration are based on the feedback information; determining CSI based on the CSI feedback configuration; and transmitting at least a portion of the CSI to the network.

In various embodiments, transmitting at least a portion of the CSI to the network may include transmitting at least a portion of the CSI to the network based on the CSI feedback configuration.

In various embodiments, any of the third and fourth methods may be implemented in a WTRU for generating CSI feedback information and transmitting the CSI feedback information to a network.

In various embodiments, the CSI being determined based on the CSI feedback configuration may include the CSI being determined from one or more measurements of the CSI-RS.

In various embodiments, the information indicating a CSI feedback configuration may include information indicating to use a CSI feedback configuration. In various embodiments, the information indicating a CSI feedback configuration may include any of an indication indicating the CSI feedback configuration, an indicator indicating the CSI feedback configuration, an information element indicating the CSI feedback configuration, and a field indicating the CSI feedback configuration.

In various embodiments, transmitting at least a portion of the CSI to the network may include transmitting a report to the network, wherein the report comprises the at least a portion of the CSI.

In various embodiments, receiving, from the network, information indicating a CSI feedback configuration may include receiving, from the network, information indicating a CSI feedback configuration responsive to the CSI feedback information transmitted to the network.

In various embodiments, the determined downlink precoding and beamforming parameters may include one or more of precoding vectors and an updated configuration of a precoding codebook.

In various embodiments, the configuration information received from the network may include any of CSI-RS location in a resource grid, subband features including subband size, a CSI correlation coefficient threshold, a cluster size, feedback size, and a duration of a CSI measurement over which beamforming and precoding vector related parameters may be determined.

In various embodiments, any of the third and fourth methods may be implemented in a WTRU.

In various embodiments, a fifth method may include any of: receiving, from a network, information indicating any of one or more metrics and one or more requirements for configuring a codebook; generating a codebook, comprising one or more first parameters, based on the one or more metrics and any of (i) one or more CSI related measurements associated with at least a first set of subbands and (ii) one or more measurements associated with a transmission, wherein the one or more first parameters comprise at least one cluster of subbands having a CSI correlation satisfying a threshold and comprising at least one subband from any of the first set of subbands and a second set of subbands that is based on the first set of subbands; and transmitting, to the network, feedback information associated with CSI, wherein the feedback information indicates (i) at least some of the one or more first parameters and (ii) one or more second parameters associated with the at least some of the one or more first parameters.

In various embodiments, the CSI information related measurements may be and/or may include one or more CSI correlation coefficients associated with at least the first set of subbands. In various embodiments, the CSI correlation coefficients may be and/or may include a CSI correlation coefficient between CSI associated with two subbands.

In various embodiments, any of the metrics and the requirements for configuring a codebook may be and/or may include a CSI correlation coefficient threshold, and wherein the threshold may be and/or may include the CSI correlation coefficient threshold. In various embodiments, any two subbands of the at least one cluster of subbands have a CSI correlation coefficient satisfying the CSI correlation coefficient threshold. In various embodiments, the fifth method may include determining the at least one cluster of subbands based on which of the one or more CSI correlation coefficients satisfy the CSI correlation coefficient threshold.

In various embodiments, determining the at least one cluster of subbands may be and/or may include applying the CSI correlation coefficient threshold to the one or more CSI correlation coefficients. Alternatively, and/or additionally, the fifth method may include applying the CSI correlation coefficient threshold to the one or more CSI correlation coefficients. In various embodiments, applying the CSI correlation coefficient threshold to the one or more CSI correlation coefficients determines a number of clusters of subbands and a size of each of the clusters of subbands, which may include a size of the at least one cluster of subbands.

In various embodiments, the one or more CSI related measurements associated with at least a first set of subbands may be and/or may include one or more estimated channel matrices for at least the first set of subbands. In various embodiments, the fifth method may include any of performing one or more measurements of reference signals (e.g., CSI-RS) associated with at least the first set of subbands, and estimating one or more channel matrices for at least the first set of subbands based on the one or more measurements.

In various embodiments, the second set of subbands that is based on the first set of subbands may be and/or may include any of (i) the second set of subbands being derived from the first set of subbands and (ii) the second set of subbands comprising some subbands of the first set of subbands.

In various embodiments, any of the metrics and the requirements for configuring a codebook may be and/or may include any of one or more CSI correlation coefficients thresholds, an activation command, a trigger to configure the codebook, and a trigger to update to a codebook.

In various embodiments, any of the metrics and the requirements for configuring a codebook may be and/or may include any of a location of reference signal in a resource grid, a subband size, a CSI correlation threshold, a cluster size, a feedback size, a duration of reference signal measurements over which a LCC range value may be updated, and scheduling information for transmitting the LCC range value.

In various embodiments, the first parameters may be and/or may include any of one or more amplitude coefficients, one or more phase coefficients, and co-phasing information.

In various embodiments, the second parameters may be and/or may include any of a set of clusters of subbands, sizes of clusters of subbands of the set of clusters of subbands, and resource blocks. In various embodiments, the set of clusters may be and/or may include the at least one cluster of subbands.

In various embodiments, the information indicating any of the metrics and the requirements for configuring a codebook may be and/or may include configuration information. In various embodiments, receiving information indicating any of the metrics and the requirements for configuring a codebook may be and/or may include receiving, configuration information indicating any of the metrics and the requirements for configuring a codebook.

In various embodiments, the transmission may be and/or may include a target transmission. In various embodiments, the transmission may be and/or may include a physical downlink shared channel transmission. In various embodiments, the codebook may be generated on a per transmission basis and/or responsive to a trigger.

In various embodiments, a sixth method may include any of: receiving, from a network, information indicating any of one or more metrics and one or more requirements for configuring a codebook; generating a codebook, comprising one or more first parameters, based on the one or more metrics and one or more CSI related measurements associated with a set of beams; and transmitting, to the network, feedback information associated with CSI, wherein the feedback information indicates (i) at least some of the one or more first parameters and (ii) one or more second parameters associated with the at least some of the one or more first parameters.

In various embodiments, the sixth method may include receiving, from the network, information indicating a CSI feedback configuration. In various embodiments, the CSI feedback configuration is based on the feedback information. In various embodiments, the sixth method may include applying the CSI feedback configuration to determine CSI and transmit at least a portion of the CSI to the network. In various embodiments, the sixth method may include any of determining CSI, and transmitting at least a portion of the CSI to the network.

In various embodiments, transmitting at least a portion of the CSI to the network may be and/or may include transmitting at least a portion of the CSI to the network based on the CSI feedback configuration. In various embodiments, the CSI being determined based on the CSI feedback configuration may be and/or may include the CSI being determined from one or more measurements of reference signals (e.g., CSI-RS).

In various embodiments, the information indicating a CSI feedback configuration may be and/or may include information indicating to use a CSI feedback configuration. In various embodiments, the information indicating a CSI feedback configuration may be and/or may include any of an indication indicating the CSI feedback configuration, an indicator indicating the CSI feedback configuration, an information element indicating the CSI feedback configuration, and a field indicating the CSI feedback configuration.

In various embodiments, transmitting at least a portion of the CSI to the network may be and/or may include transmitting a report to the network, wherein the report may be and/or may include the at least a portion of the CSI.

In various embodiments, receiving, from the network, information indicating a CSI feedback configuration may be and/or may include receiving, from the network, information indicating a CSI feedback configuration responsive to the CSI feedback information transmitted to the network.

In various embodiments, the first parameters may be and/or may include downlink precoding and beamforming parameters. In various embodiments, the downlink precoding and beamforming parameters may be and/or may include one or more of precoding vectors and an updated configuration of a precoding codebook.

In various embodiments, any of the metrics and the requirements for configuring a codebook may be and/or may include any of a reference signal location in a resource grid, a subband feature (e.g., including subband size), a channel state information correlation coefficient threshold, a cluster size, a feedback size, and a duration of a channel state information measurement over which beamforming and precoding vector related parameters may be determined.

In various embodiments, any of the fifth method and the sixth method may be implemented in a WTRU.

In various embodiments, an apparatus, which may include any of a processor and memory, configured to perform a method as in the first-sixth methods and/or at least one of the preceding embodiments. In various embodiments, the apparatus may be, may be configured as and/or configured with elements of a WTRU.

### Representative WTRU-Specific CSI Codebook Design and Feedback Thereof

The term W1 herein may refer to parts of the codebook that represent long term CSI feedback and/or properties of the channel expected to be updated on a relatively longer time scale. The term W1 may refer to parts of the codebook that are applicable to wideband. The term W2 may refer to parts of the codebook that represent short term CSI feedback and/or properties of the channel that are updated at a relatively shorter time scale. The term W2 may refer to parts of the codebook that are applicable to wideband subband or wide band. Even though the embodiments are described herein mostly in terms of W1 and W2 codebooks, the embodiments are applicable to codebooks that are composed of an arbitrary number of W matrices (e.g., W1, W2, . . . Wn). Even though the solutions are expressed in terms of W1 and W2 codebooks, the solutions are also applicable to CSI feedback that is based on reporting indices (e.g., i1, i2 etc.) to these codebooks. One or more embodiments relating to codebook configuration may be exemplified in terms of parameters like subband size, LCC, etc. but are not limited to those parameters and should be applicable to any parameter related to CSI feedback.

AIML is considered here as an example enabler for WTRU-specific codebook determination, however, the solutions are not limited to AIML-based approaches.

### Representative WTRU-Specific W2 Codebook

Representative Feedback Associated with WTRU-Specific W2 Codebook Determination

In a high-level description of one embodiment (wherein details are provided herein), an AIML module, e.g., neural network may be configured to determine Type II CSI configuration. Inputs to the neural network may be a channel matrix (CSI) and the output of the neural network may be a Type II CSI configuration including quantization of power scaling per antenna, subband size, etc., i.e., W2 codebook parameters.

Also, the selection of LCC, i.e., W2 codebook parameters, is typically based on a pre-determined codebook, i.e., a fixed range for amplitude and phase coefficients, and a pre-determined quantization level. In one approach, the LCC range and W2 codebook parameters may be adapted to the underlying environment and channel statistics, as opposed to the current state-of-the art pre-determined values.

### Representative LCC Value or LCC Value Range, Quantization Aspects

In an embodiment, the following steps and components may be used to identify LCC (W2) values, or LCC (W2) statistics, or feedback quantization values.

A WTRU may perform training of a neural network (e.g., a DNN) offline or online with one or more of the following:
Input: CSI feedback related parameters including at least one of a set of subbands, number of subbands, subband size, CSI feedback type, codebook type, and/or codebook configuration parameters.
Input: channel measurement related information including at least one of CSI-RS received amplitude/phase per subband, estimated channel matrix per subband, estimated QCL parameters (e.g., Doppler shift, Doppler spread, average delay, delay spread, spatial receive filter).
Output: CSI reporting quantities including at least one of: PMI, RI, CQI, CRI, and LI.
Output: W2 LCC coefficients, e.g., amplitude/power scaling per antenna, phase coefficients, column id, and co-phasing between two polarizations per the output subband cluster/bundle.
Output: determined CSI reporting overhead, which may be indicated as CSI reporting configuration index, wherein the CSI reporting configuration index may be associated with a codebook configuration (e.g., number of beams, quantization level of amplitude/phase, subband size, time domain prediction, etc. for one or more component precoders of a codebook).

Using the trained neural network, the WTRU may obtain and send feedback to a gNB, e.g., a W2 LCC coefficient (quantized or raw) per resource block cluster.

The gNB may select, configure, and/or indicate the WTRUs for AIML based on conventional LCC range determination. This may be done based on WTRU-specific feedback to select the LCC mode selection, such as, e.g., (i) AIML-based, or (ii) conventional.

The selection of WTRU(s) for AIML LCC range configuration might depend on a high resolution vs a low resolution CSI requirement, including SU-MIMO or MU-MIMO scheduling. For low resolution CSI requirement (e.g., SU-MIMO, low-mobility), in one embodiment, the WTRU(s) may be configured to use a conventional LCC range.

The grouped WTRUs for MU-MIMO operation might be configured to operate at AIML-based LCC range determination or statistics.

A neural network (e.g., a DNN) may be trained with the following labeled data: (i) input: CSI-RS measurement, e.g., Channel Frequency Response/Channel Impulse Response (CIR/CFR) values (i.e., per subband); (ii) output: optimal LCC values including amplitude/power scaling per antenna, phase coefficients, column id, and co-phasing between two polarizations for specific size and resolution (i.e., R number of quantized bits); (iii) online learning of LCC range values. The AIML module might keep a record of the optimal LCC values over a given time period where the time period may be determined and informed by the gNB, or locally by the WTRU. The updated LCC range values may be fed back to the gNB periodically, semi-periodically, or in a bit error rate/frame error rate (BER/FER) event-based fashion.

The WTRU may be configured to transmit feedback of the LCC statistics, such as LCC range values per cluster or overall clusters, to the gNB.

The WTRU may receive an activation/indication message from the gNB regarding the updated LCC range values and/or quantization levels.
Option:1 Fixed LCC range—variable quantization level
Option:2 Fixed quantization level—variable LCC range

The feedback associated with the subband reporting for both Type I and Type II codebook includes the amplitude coefficients, phase coefficients, and co-phasing information between the two polarizations. This overhead scales up linearly with the number of subbands. The feedback overhead can be reduced by reducing the number of bits used to quantize the respective values at the expense of precision. The WTRU may first determine an appropriate codebook type or a range of values for each of the reported CSI quantities and then choose a feedback value from the selected codebook or reporting range.

The WTRU may be configured with a set (or a subset) of W2 codebooks by the network. Each codebook within the codebook set may be identified by a unique identifier. Each codebook may contain a set of coefficients corresponding to the number of active antenna elements. Individual codebooks may have a different number of columns (e.g., a different number of codewords in each component precoder, thus requiring a different number of bits for reporting the determined codeword) and may therefore require a different number of bits to identify a particular column. Hereafter, column for a codebook may be interchangeably used with precoder, codeword, PMI, matrix, and vector. Identity of column may be interchangeably used with precoding index, precoding matrix index (PMI), precoding identity, and codeword index.

The WTRU may select or determine (e.g., generate) a codebook from the codebook set based on at least one of: (i) channel measurements for each subband, (ii) conventional algorithms, (iii) AIML techniques, (iv) CSI reporting timing, (v) CSI reporting configuration, and (vi) an uplink resource used for the CSI reporting.

Regarding the channel measurements for each subband basis, the codebook choice may depend on the number, N, of channel measurements. The WTRU may choose a codebook from the codebook set that is optimum for the N measurements. The value of N may be either configured by the network or may be a WTRU-determined parameter. The WTRU may determine a codebook for one or more subbands within the CSI reporting band.

Regarding the conventional algorithms or AIML techniques bases, the WTRU may indicate its capabilities, e.g., capable of conventional algorithm-based codebook selection, AIML-based codebook selection, or both, to the network. The WTRU may be informed by the network about the method to be used for codebook determination. The WTRU may utilize either offline training or online training if it chooses AIML-based codebook selection.

Regarding the CSI reporting timing basis, as an example, if a time gap between CSI-RS measurement and its associated CSI reporting is less than a threshold, the WTRU may determine a first codebook from the codebook set; otherwise, the WTRU may determine a second codebook from the codebook set, wherein the threshold may be configured or determined based on whether an AIML technique or conventional algorithm is used.

Regarding the CSI reporting configuration basis, the CSI reporting configuration may include at least one of CSI reporting band size, subband size, CSI reporting channel (e.g., PUCCH, PUSCH, PUCCH format), CSI reporting periodicity (e.g., periodic, aperiodic, semi-persistent), CSI reporting priority, etc.

Regarding the uplink resource used for the CSI reporting basis, as an example, a WTRU may determine to use a first codebook when a first type of uplink resource is used for CSI reporting (e.g., PUSCH) and the WTRU may determine to use a second codebook when a second type of uplink resource (e.g., PUCCH) is used. Alternatively, a WTRU may determine a codebook from a first subset of codebooks when a first type of uplink resource is used for CSI reporting; and may determine a codebook from a second subset of codebooks when a second type of uplink resource is used for CSI reporting.

The WTRU may report a codebook choice to the network. The WTRU may be configured to either report a single codebook for all subbands or an individual codebook for each reported subband. The WTRU may report the choice of codebook and the column within the codebook either within the same report or in one or more different reports. The reporting periodicities of the codebook selection and the column index may be different, e.g., the column index may be reported more frequently than the codebook.

The WTRU may be configured with a set of LCC ranges by the network. Each LCC range may be identified by a unique identifier. Each LCC range may be associated with a different number of bits for reporting.

For each subband, the WTRU may select an LCC range from the configured set of LCC ranges based on channel measurements. The choice of LCC range may depend on the number of channel measurements, N. The WTRU may choose an LCC range from the configured set of LCC ranges that is optimum for the N measurements. The value of N may be either configured by the network or may be a WTRU-determined parameter.

The WTRU determination of the LCC range may be based on conventional algorithms or may use AIML techniques. The WTRU may indicate its capabilities, e.g., capable of conventional algorithm-based LCC range selection, AIML-based codebook selection, or both, to the network. The WTRU may be informed by the network about the method to be used for LCC range determination. The WTRU may utilize either offline training or online training if it chooses AIML-based LCC range selection.

The WTRU may report its choice of the LCC range to the network. The WTRU may be configured to either report a single LCC range for all subbands or individual LCC ranges for each reported subband. The WTRU may report the choice of LCC range and the LCC value within the range either within the same report or in one or more different reports. The reporting periodicities of the LCC range choice and the specific LCC value within the range may be different, e.g., the LCC value may be reported more frequently than the LCC range. The WTRU may report a common LCC range for all subbands and individual LCC values for each subband.

The WTRU may be configured to report 1) choice of LCC range and LCC value within the range, or instead 2) an LCC value only from a default LCC range that was pre-configured by the network. The reporting periodicities of the conventional LCC value and the combination of WTRU selected LCC range and value may be different.

Other configuration aspects of a W2 codebook may be modified. The WTRU may use AIML algorithms to determine the appropriate quantities related to LCC values, including amplitude/power scaling per antenna, phase coefficients, column id, and co-phasing between two polarizations for specific size and resolution (i.e., R number of quantized bits). The LCC values may be initially determined by performing offline training.

The WTRU may subsequently determine that it needs to perform online training to update the LCC values. This determination may be made, for example, when the distribution of the observed channel measurements differs from the distribution of the channel measurements used for offline training; and/or when CSI feedback accuracy is below a threshold, wherein the CSI feedback accuracy may be determined based on one or more of following (i) DL performance (e.g., a block error rate (BLER) of a PDSCH transmission); (ii) a difference between CSI reporting determined based on AIML-based and conventional-based mechanism; and (iii) a number of consecutive HARQ-NACK for PDSCH.

Alternately, and/or additionally, the WTRU may determine that it requires online training by periodically using an expanded LCC value range to determine the optimum LCC value. If the transmission quality using the expanded range is better than the range originally used by the WTRU, then it may determine that online training is needed to determine a new LCC range. The WTRU may determine the transmission quality by observing the BER or BLER or another parameter.

In one embodiment, the amount of online training needed may be determined by the WTRU. In such a case, the WTRU may inform the network of its retraining needs, e.g., number of samples needed, time duration of the samples, etc.

In another embodiment, the determination of the need for online training may be made by the network and signaled to the WTRU. In such a case, the WTRU may be either informed of the criterion to stop online training, e.g., when the error between output of the re-trained network and labeled values is less than a particular threshold, or may be informed of the number of samples available for online training.

The end of the online training phase may be either implicitly known when the pre-configured number of samples are transmitted by the network, or may be signaled by the WTRU, when it determines that the output of the trained network differs from the labels by a value smaller than a threshold.

The WTRU may report LCC values from a default LCC value range during the interval that it is performing online training. The time for switching to the AIML trained LCC range may be either signaled by the network or may occur implicitly after a pre-defined duration following the end of online training.

### Representative Dynamic Subband Clustering and LCC Values Thereof

The feedback overhead associated with the subband reporting (referred to as i₂ reporting) for Type I or Type II codebook scales up with the number of subbands. The i₂ reporting includes the amplitude coefficients, phase coefficients, and the co-phasing information between two polarizations, for each subband. Thus, to reduce the feedback overhead associated with i₂, the WTRU may be configured to reduce the number of subbands that capture the entire CSI information. For instance, the WTRU may be configured to determine a reduced set of subbands (and/or other representative set of subbands), possibly with a different number of resource blocks (RBs) allocated to each subband, with each subband satisfying a certain (e.g., preconfigured) correlation threshold.

The WTRU may be configured to determine and report a reduced set of subbands and their associated RBs if the coherence bandwidth, B_{c}, exceeds a certain threshold. The WTRU may perform measurements to determine the coherence bandwidth as

$${B}_{c} = \frac{1}{5 {τ}_{rms}} \qquad ( 1 )$$

where τᵣₘₛ is the root mean square (rms) delay spread. The RBs associated with each subband may be contiguous or non-contiguous.

If the WTRU is configured to perform dynamic subband clustering, the WTRU may determine a set of clusters of RBs if the measured coherence bandwidth exceeds a certain preconfigured threshold B̅_{c} (expressed in RB units).

The WTRU may perform measurements on estimated channel matrices to determine the set of clusters and the candidate RBs associated with each cluster. For example, given the estimated channel {H[k]}ₖ₌₁^{N}^{_{RB}}, where N_{RB} denotes the total number of RBs, the WTRU may determine the set of clusters based on a function, ƒ({H[k]}ₖ₌₁^{N}^{_{RB}}). The function may be chosen as the correlation matrix Σ∈C^{N}^{_{RB}}^{×N}^{_{RB}},

$${\sum }_{ij} = \frac{\vert {h}_{i}^{*} {h}_{j} \vert}{‖ {h}_{i} ‖ ‖ {h}_{j} ‖} \qquad ( 2 )$$

where hᵢ∈C^{N}^{ₜ}^{N}^{ᵣ} represents the vectorized channel matrix H[i], i=1, . . . , K. The WTRU may form the subband by grouping the RBs with the minimum pair-wise correlation satisfying a certain preconfigured correlation threshold. For example, the WTRU may form the n^{th} subband with the RBs (i₁ₙ, . . . , i_{K}_{ₙ}ₙ) if the pair-wise correlation between each two candidate RBs exceeds a (e.g., preconfigured) correlation threshold ρₜₕ, for n=1, . . . , N_{c}, and N_{c} is the number of subbands/clusters.

The WTRU may report the identified subbands together with (i₁ₙ, . . . , i_{K}_{ₙ}ₙ), for n=1, . . . , N_{c}. The WTRU may derive/report the i₂ indices including: the amplitude coefficients pₙ=(p₀, p₁, . . . , p_{2L-1}) and the phase coefficients i_{2,1,n}=(c₀, c₁, . . . , c_{2L-1}), associated with the n-th identified subbands, where 2L represents the number of configured beams for both polarization directions.

The WTRU may perform clustering in the precoding domain. As an alternative for clustering followed by precoding, the WTRU may first derive the i₂ indices for each channel {H[k]}ₖ₌₁^{N}^{_{RB}}, then cluster/combine the RBs that yield the same i₂ indices. For example, the WTRU may first determine the amplitude coefficients pₖ=(p₀, p₁, . . . p_{2L-1}) and the phase coefficients i_{2,1,k}=(c₀, c₁, . . . , c_{2L-1}), then the WTRU may determine a reduced set of subbands N_{c} based on a function f(i_{2,1,k}, pₖ) that outputs i_{2,1,n}, pₙ and (i₁ₙ, . . . , i_{K}_{ₙ}ₙ), for n=1, . . . , N_{c}.

For example, the WTRU may be configured to group the RBs that result in an angle and/or amplitude difference below a preconfigured thresholds δc and/or δp, respectively, or a weighted combination of both δc and δp. The WTRU may determine i_{2,1,n}, pₙ and (i₁ₙ, . . . , i_{K}_{ₙ}ₙ), based on a function f(i_{2,1,k}, pₖ, δc, δp), where δc and δp are either configured by gNB or recommended by the WTRU to satisfy a certain feedback overhead constraint for the i₂ reporting.

The WTRU receives configuration related to CSI-RS processing, wherein the information may include (i) CSI-RS location in resource grid, corresponding subband features including subband size; and/or (ii) CSI feedback related information, e.g., CSI correlation coefficient threshold, cluster size, feedback size, etc.

The WTRU employs a neural network (e.g., a DNN), which may be trained offline or online. The neural network may have the attributes: (i) input: A set of subbands; CSI-RS received amplitude/phase per subband, and/or (ii) output: Subband clusters/bundles per correlated CSI (e.g., a correlation coefficient threshold may be predetermined, or the subband clusters may be selected to improve/satisfy given KPIs, such as SNR, number of streams, etc.), W2 LCC coefficients, i.e., amplitude/power scaling per antenna, phase coefficients, column id and co-phasing between two polarizations per the output subband cluster/bundle.

The WTRU determines CSI per subband, e.g., (i) subband clusters or bundles that have CSI correlation above a threshold, and/or (ii) WTRU-specific LCCs (i.e., amplitude/power scaling per antenna, phase coefficients, co-phasing between two polarizations) per subband cluster, where the subbands may be non-contiguous. The WTRU inputs subband-specific CSI values (i.e., amplitude, phase) and subband features (i.e., subband size and location) to a trained neural network, e.g., to determine one or more aspects associated with CSI.

The WTRU transmits feedback to the gNB including one or more of the subband cluster/bundle features (e.g., locations of the subbands that are in the cluster, size of the cluster, new size, and location of the subbands in the cluster, etc.), the LCC values per cluster, and a time-window where the LCC values are predicted to be constant.

### Representative Neural Network Configuration for WTRU-Specific W2 Codebook

A neural network may be configured to determine the LCC values and their statistics. In the inference phase, e.g., for a neural network that is already trained either offline or online, the following input and output parameters may be considered:
input: a set of subbands; CSI-RS received amplitude/phase per subband; and
output: subband clusters/bundles per correlated CSI (e.g., a correlation coefficient threshold could be predetermined or the subband clusters could be selected to improve/satisfy given KPIs, such as SNR, number of streams, etc.). W2 LCC coefficients, e.g., amplitude/power scaling per antenna, phase coefficients, column id and co-phasing between two polarizations per the output subband cluster/bundle.

### Representative WTRU-Specific W2 Reconfiguration and CSI Transmission Based on WTRU-Specific W2 Codebook

A WTRU may determine the value of one or more parameters associated with CSI feedback and/or CSI codebook dynamically (e.g., based on WTRU measurements/observations). In one or more embodiments herein, the CSI feedback or parts thereof derived based on parameters and/or parameter ranges determined by the WTRU may be referred to as a WTRU-specific CSI codebook. Possibly, such determination may be based on machine learning-based algorithms. In an embodiment, the WTRU may be configured to apply reporting configuration for CSI feedback based on a WTRU-specific codebook. Possibly, the WTRU may apply such CSI reporting configuration after receiving implicit and/or explicit activation from the network. The WTRU-specific CSI codebook may include configuration of one or more of the following: LCC values, LCC range, quantization levels, subband cluster/bundle features (i.e., locations of the subbands that are in the cluster, size of the cluster, new size, and location of the subbands in the cluster etc.), the LCC values per cluster, and a time-window where the LCC values are predicted to be constant. For example, the WTRU may be configured to determine subband clusters for reporting CSI based on a WTRU-specific CSI codebook. In one example, the WTRU may determine subband clusters such that the subbands within a subband cluster are contiguous. In another example, the WTRU may determine subband clusters such that subbands within a subband cluster are contiguous or non-contiguous. In another example, the WTRU may be configured with a maximum number of subband clusters that can be reported. In another example, the WTRU may be configured with a maximum number of subbands that can be a part of a subband cluster. In another example, the WTRU may be configured to determine an optimal subband size such that the number of clusters are minimized and/or the CSI overhead is reduced. Possibly, the WTRU may be configured to transmit one or more recommended/preferred parameters related to subbands, e.g., subband cluster structure (e.g., contiguous, or non-contiguous), number of clusters, subband size, subband cluster size, etc., as a part of WTRU feedback. The WTRU may be configured with a LCC value range and quantization level as a part of the WTRU-specific CSI codebook. In one example, the WTRU may be configured with a variable quantization level range, and the WTRU may determine the appropriate quantization level based on WTRU feedback associated with W2 codebook determination. In another example, the WTRU may be configured with a fixed quantization level and variable LCC range, and the WTRU may determine the appropriate LCC value based on WTRU feedback associated with W2 codebook determination.

In various embodiments, a WTRU may apply a WTRU-specific CSI codebook configuration upon receiving an acknowledgement to a previous WTRU feedback associated with WTRU-specific CSI codebook parameter recommendation.

In one embodiment, the WTRU may be configured to apply a WTRU-specific CSI codebook configuration upon receiving an acknowledgement of a previous WTRU feedback associated with a WTRU-specific CSI codebook parameter recommendation. Possibly, the acknowledgement may be a HARQ acknowledgment—for, e.g., when the WTRU feedback is transmitted via PUSCH. Possibly, the acknowledgement may be in a MAC CE (Media Access Control-Control Element)—for, e.g., when the WTRU feedback is carried in PUCCH or PUSCH. The WTRU may be configured to start a timer with a preconfigured duration upon transmitting the WTRU feedback associated with a WTRU-specific CSI codebook parameter recommendation. The WTRU may ignore the WTRU feedback and continue using the previous CSI codebook configuration if the timer expires before an acknowledgement is received from the network.

In various embodiments, a WTRU may apply a WTRU-specific CSI codebook configuration based on a logical index indicated by the activation command wherein the logical index may refer to a previous WTRU feedback associated with the WTRU-specific CSI codebook parameter recommendation.

In another embodiment, the WTRU may be configured to associate/tag a unique logical index to each WTRU feedback associated with a WTRU-specific CSI codebook parameter recommendation. In addition, the WTRU may transmit the logical index along with the WTRU feedback. For example, the WTRU may associate a logical index, n, with WTRU feedback indicating the recommended LCC value range from x to y. For example, the WTRU may associate logical index n+1 with WTRU feedback indicating the recommended subband cluster value to be z. Upon receiving an activation command carrying a logical index n+1, the WTRU may apply the recommended subband cluster value to be z. In some embodiments, the logical index may be derived implicitly, e.g., referring to the UL time/frequency resources used for such feedback. For example, the activation command may carry a logical index which may be derived as a function of the UL slot carrying the feedback and as function of the starting PRB identity of the PUCCH carrying the feedback. If the activation command does not indicate any logical index, then, by default, the UE may apply the WTRU-specific CSI codebook configuration indicated in the most recent feedback.

In various embodiments, a WTRU may apply a WTRU-specific CSI codebook configuration based on a logical index indicated by the activation command wherein the logical index may correspond to a specific configuration set within a plurality of preconfigured CSI configuration sets.

In yet another embodiment, the WTRU may be preconfigured with a list of configuration sets including allowed CSI parameters/ranges associated with WTRU-specific CSI codebook. Possibly, the WTRU may receive such pre-configuration in a RRC message. For example, allowed parameters may include a range of LCC coefficients, subband clusters, quantization level, etc. Each configuration set may be associated with a logical index. The WTRU may receive an activation MAC CE from a gNB, wherein the activation command may carry the logical index associated with a configuration set applicable for CSI feedback.

In one or more embodiments above, the WTRU may apply a WTRU-specific CSI codebook configuration at a preconfigured time offset. In an embodiment, the preconfigured time offset may be a time offset from the timing of the WTRU feedback associated with the WTRU-specific CSI codebook parameter recommendation. In another embodiment, the preconfigured time offset may be an offset from the timing of reception of an activation command. Possibly, the preconfigured time offset may be implicit based on configuration of a WTRU-specific CSI codebook parameter. Possibly, the time offset may be explicitly configured in the activation command. Upon applying the WTRU-specific CSI codebook configuration, the WTRU may perform transmission of CSI feedback based on the WTRU-specific CSI codebook.

In one or more embodiments above, the activation of a WTRU-specific CSI codebook configuration may implicitly or explicitly activate additional configurations. For example, the activation of a WTRU-specific CSI codebook configuration may imply that the WTRU may use a set of CSI-RS resource configurations that may be preconfigured for CSI feedback transmission based on the WTRU-specific CSI codebook. For example, the activation of a WTRU-specific codebook configuration may imply that the WTRU may use UL resources (e.g., PUCCH and/or PUSCH resources) preconfigured for transmission of CSI feedback based on the WTRU-specific CSI codebook.

### Representative WTRU-Specific W1 Codebook

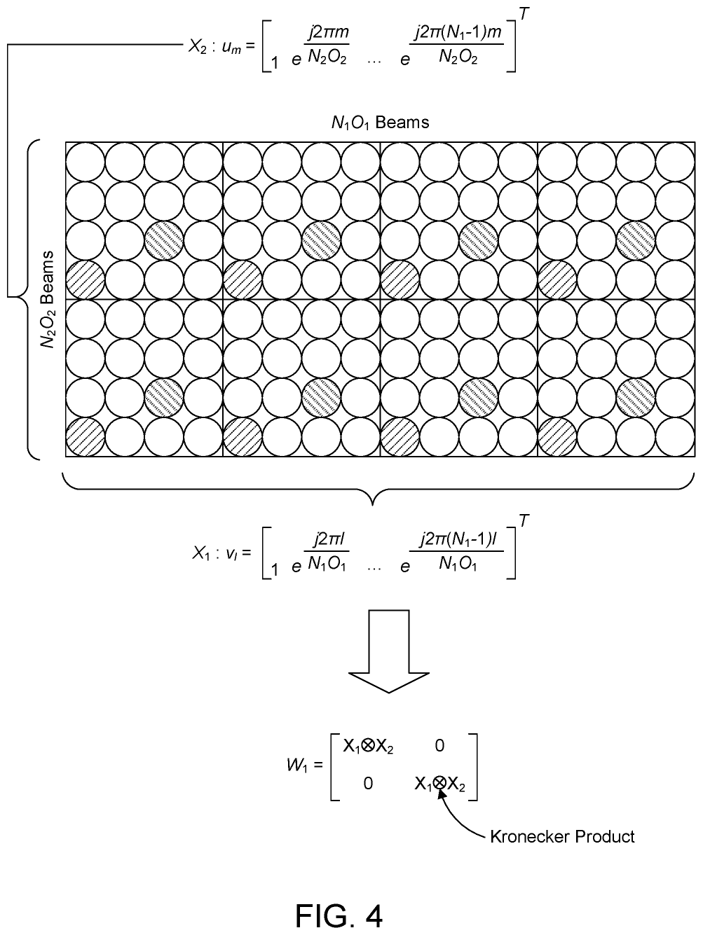

In NR, the construction of a W1 matrix is based on determining antenna scaling coefficients, in terms of amplitude and phase, which is typically selected from over-sampled DFT vectors. The pre-defined W1 matrix, available both to the gNB and WTRU, identifies the orthogonal beams with specific beam sweep steps. For an antenna-panel with a number, N₁, of horizontal antennas, a number, N₂, of vertical antennas, a number, O₁, of horizontal beam sweep steps, and a number, O₂, of vertical beam sweep steps, the W1 matrix have a size N₁×O₁ by N₂×O₂, wherein each entry defines a particular beam, and the W1 matrix contains a given number (e.g., O₁×O₂) of orthogonal beams as well as a number of rotated DFT beams. A description of a W1 codebook in accordance with such an embodiment is shown in FIG. 4.

Representative Feedback Associated with WTRU-Specific W1 Codebook Determination

In one approach, the transmitter and receiver pair, or each node individually, may determine or develop beams that may or may not be part of the W1 codebook. In one option, the transmitter sends CSI-RS signals to the receiver in a pre-defined/configured time/frequency location that is available/known to both nodes. Alternately, the transmitter and/or network may inform the receiver of the CSI-RS time/frequency locations that may be used in the new beam measurement and determination campaign. This information may be, for example, part of an RRC configuration message, transmitted as part of DCI message, etc.

Once the CSI-RS signals are received, the receiver (e.g., WTRU) may determine and collect various CSI related information, including SNR, BER, channel amplitude information, channel phase information, etc., per received CSI-RS signal or over a collection of received CSI-RS signals. The obtained channel related information and/or statistics may be used to identify new beams using different model-based or non-model-based methods, including data-driven and/or AIML-based decision-making blocks. AIML-based decision-making blocks may be designed to be comprised of conventional training and inference stages. The training phase may be performed offline, online, or in a hybrid offline and online fashion. Once the AIML-based decision-making block is trained, the block may be used in an inference stage to obtain the desired outputs, i.e., in this case, a new set of beams and beam-specific features.

A possible embodiment for AIML-based beam determination, where AIML decision-making block is assumed to be already trained and is in inference stage, may include:
Inputs to the AIML decision-making block: SNR, BER (with a stream of bits, or packet transmission in which the CSI-RS could be a part thereof), channel amplitude information, channel phase information, channel amplitude and/or phase time, and frequency correlation information. The inputs may be per CSI-RS signal or per a collection of the received CSI-RS signals over a time or frequency duration, which duration may also be part of the input set. The input set also may include information regarding the transmit beam that the CSI-RS might be multiplexed with, e.g., its id and/or location in the overall Tx beam set. In an option, the AIML decision-making block may include the transmitter or receiver behavioral features, i.e., mobility pattern, device capacity, and also the traffic class information with corresponding QoS requirements of the scheduled traffic flows.
Output of the AIML decision-making block: A set of beams, where a set may be composed of a single or multiple beams, per the given input set, where a beam may be identified by one or multiple of the parameters including antenna amplitude and phase scaling factor, beam width, beam direction, e.g., angle-of-arrival (AoA) or angle-of-departure (AoD), etc. In one embodiment, the beams and beam-specific features that are described previously, and the corresponding input set may be stored in the memory for future reference and collection of input set and beam-specific statistics.

The disclosed operation will enable the receiver to identify transmit beams that are expected to provide better performance in the upcoming Transmission Time Intervals (TTIs), which may be fed back to the transmitter. The collection of selected transmit beams may be performed over a given time and measurement period, e.g., T_{beam_select}. T_{beam_select} may be determined by the transmitter, e.g., gNB, which may inform the receiver, e.g., WTRU, of it in a downlink control message, such as DCI, or part of PDCCH, or part of MAC CE, or part of RRC configuration. Alternatively, the WTRU may also locally determine the measurement period to collect the transmit beams and their beam-specific features.

Once the receiver identifies the beams and their features within one or multiple measurement periods, the WTRU may perform a W1 precoder codebook update, e.g., to the codebook that contains oversampled-DFT matrices that are selected for linear combination that are chosen from a given W2 codebook. With the new beams and their features available, the receiver will be able to identify any necessary update to the precoder codebook which, in effect, might lead to a receiver or WTRU-specific codebook structure. The update may include any of the following (or any other modification to the existing codebook structure): (i) addition of new precoder matrices (e.g., columns, codewords, precoders) that represent some or all of the newly identified beams; (ii) addition and/or removal of a component codebook which may represent at least one of frequency domain, time domain, and/or spatial domain; (iii) a number of component codebooks, which may be determined based on addition/removal of component codebook; (iv) CSI feedback overhead, which may be determined based on the number of component codebooks; (v) changing at least some of the already existing precoder matrices in the codebook, which could include removal of some of the columns in a matrix, linear or non-linear combination of some of the columns in a matrix, addition of new columns in a matrix, compression and/or size reduction of a matrix, etc.; and (vi) removal of at least some of the matrices (e.g., columns, codewords, precoders) from the codebook.

The receiver, e.g., the WTRU, may inform the transmitter, e.g., a gNB, regarding the proposed updates on the codebook. Before providing the update information, the receiver may send a codebook update trigger message, e.g., trigger_codebook_update, to the transmitter. The proposed updates, which may include part, or all of the codebook modification list described above, may be conveyed by the receiver using a codebook update message, e.g., msg_codebook_update, which may be part of UCI, PUCCH, PUSCH, or MAC CE. The receiver may send the msg_codebook_update message in different formats and time allocations, which could be configured by the transmitter in a downlink codebook_update_config message transmitted as a part of DCI, PDCCH, PDSCH, MAC CE, or RRC configuration, each with varying periodicities.

Once the msg_codebook_update message is received, the transmitter may inform the WTRU about its decision on the codebook update, where the gNB might accept/reject the updates in the msg_codebook_update message or configure a new codebook that may be different than the updates proposed in the msg_codebook_update message as suggested by the receiver. The transmitter may then inform the receiver regarding the codebook configuration in a feedback_msg_codebook update message in the downlink, which could be part of PDCCH, PDSCH, MAC CE, or RRC configuration, each with varying periodicities.

Other configuration aspects of a W1 codebook may be modified. In one embodiment, the receiver, e.g., WTRU, may be configured with a receiver-specific W1 codebook, whilst also the codebook may be configured per subband or a group of subband resource units. The grouping of subband resource units, e.g., as disclosed herein supra in connection with dynamic subband clustering and LCC values thereof, may also be extended to the WTRU and subband cluster-specific configuration of the W1 codebook. The transmit beam determination at the receiver that is configured over a measurement period, Tbeam_select, may be specific to subband resource unit clusters, e.g., for each subband cluster, the receiver may collect and identify the transmit beams and their features. In one embodiment, in order to reduce the W1 related uplink feedback overhead, the subband clusters at the receiver may be a time averaged representation such that the identified beams and updated codebook may be associated with a subband cluster over a predefined period of time. The subband cluster information, along with the time duration over which the codebook updates should be performed, may be determined and conveyed by the transmitter, e.g., gNB, to the receiver, e.g., WTRU, in a downlink control message, such as DCI.

### Representative Neural Network Configuration for WTRU-Specific W1 Codebook

A neural network may be used to perform AIML-based beam and beam feature determination at the receiver, or alternatively, at the transmitter. The neural network may be trained offline, online, or in a hybrid offline-online mode. In the case of the receiver employing a neural network to identify receiver/WTRU-specific beams and codebook updates, and with offline training, the receiver shall be provided with the neural network parameters, e.g., network coefficients and architecture parameters. The trained neural network is then used for the beam and beam-feature determination at the receiver during the inference stage.

In the offline or online training of a neural network, the following input and output labelled data may be used:
input data: wideband or subband-specific SNR, BER (with a stream of bits, or packet transmission in which the CSI-RS could be a part thereof), channel amplitude information and statistics, channel phase information and statistics, channel amplitude and/or phase time and frequency correlation information; and
output data: optimal transmit beams and their features, including the parameters such as antenna amplitude and phase scaling factor, beam width, beam direction, e.g., AoA or AoD, etc.

### Representative WTRU-Specific W1 Reconfiguration and CSI Transmission Based on WTRU-Specific W1 Codebook

The WTRU receives configuration information from a gNB to be used in the neural network based procedures, such as CSI-RS and beamforming codebook related information, including, any of (i) a CSI-RS location in resource grid, corresponding subband features including subband size; (ii) CSI feedback related information, e.g., CSI correlation coefficient threshold, cluster size, feedback size, QCL parameters, etc.; (iii) a duration of the CSI measurement over which the beamforming and precoding vector related parameters, i.e., beamforming antenna coefficients, may be determined; and (iv) timing and/or scheduling information for the uplink feedback of the new precoding vectors or update configuration of the existing codebook.

The WTRU transmits feedback to the gNB regarding the new precoding vectors or updated configuration of the existing codebook. The WTRU receives a beamforming reconfiguration message from the gNB regarding the new precoding vector sets or updated codebook. The WTRU receives activation/indication message from the gNB and receives the downlink transmission based on the updated codebook.

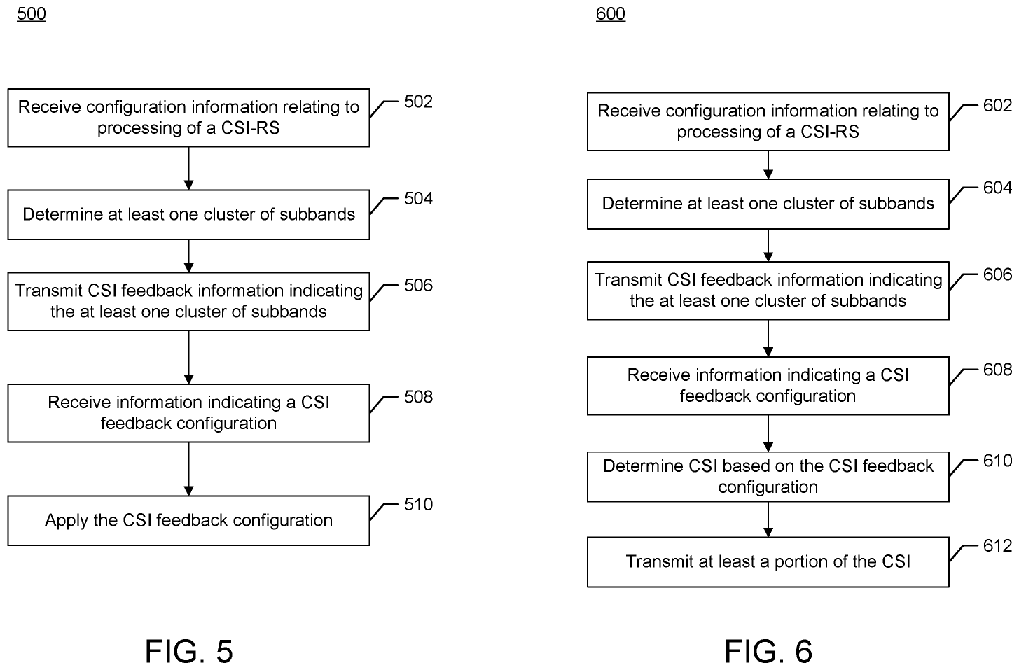

FIG. 5 is a flow chart illustrating an example flow 500 for carrying out WTRU-specific W2 codebook generation and/or providing information associated with the generated WTRU-specific W2 codebook. The flow 500 and accompanying disclosures herein may be considered a generalization of at least some of the disclosures above and are considered to encompass and/or include various embodiments of the disclosures above (e.g., the various embodiments of the feedback associated with WTRU-specific W2 codebook determination and/or the dynamic subband clustering and LCC values thereof disclosed herein). The flow 500 may be carried out using the architecture of the communications system 100 of FIGS. 1A-1D. The flow 500 may be carried out using other architectures as well.

Referring to FIG. 5, a WTRU may receive, from a network, configuration information relating to processing of a CSI-RS (502). The WTRU may determine at least one cluster of subbands that have CSI correlation above a first threshold (504). The WTRU may transmit CSI feedback information to the network, wherein the CSI feedback information indicates the at least one cluster of subbands (506). The WTRU may receive, from the network, information indicating a CSI feedback configuration (508). The CSI feedback configuration and/or the information indicating the CSI feedback configuration may be based on the CSI feedback information. The WTRU may apply the CSI feedback configuration (510), e.g., to determine CSI and transmit at least a portion of the CSI to the network.

In various embodiments, the WTRU may transmit at least a portion of the CSI to the network. In various embodiments, the WTRU may transmit, for example, at least a portion of the CSI to the network based on the CSI feedback configuration.

In various embodiments, the CSI being determined based on the CSI feedback configuration may include the CSI being determined from one or more measurements of the CSI-RS. In various embodiments, the information indicating a CSI feedback configuration may include information indicating to use a CSI feedback configuration. In various embodiments, the information indicating a CSI feedback configuration may include any of an indication indicating the CSI feedback configuration, an indicator indicating the CSI feedback configuration, an information element indicating the CSI feedback configuration, and a field indicating the CSI feedback configuration.

In various embodiments, the WTRU may transmit a report to the network and the report may include the at least a portion of the CSI.

In various embodiments, the WTRU may receive the information indicating a CSI feedback configuration responsive to the CSI feedback information transmitted to the network.

In various embodiments, the configuration relating to processing of a CSI-RS may include any of a location of CSI-RS in a resource grid, subband size, a CSI correlation threshold, cluster size, feedback size, a duration of CSI-RS measurements over which a LCC range value may be updated, and scheduling information for feedback of the LCC range value.

In various embodiments, the subbands in the cluster can be non-contiguous.

In various embodiments, the CSI feedback information may include any of locations of the subbands in the cluster, size of the cluster, LCC values per cluster, LCC statistics, and a time-window in which the LCC statistics are predicted to be within a second threshold.

FIG. 6 is a flow chart illustrating an example flow 600 for carrying out WTRU-specific W2 codebook generation and/or providing information associated with the generated WTRU-specific W2 codebook. The flow 600 and accompanying disclosures herein may be considered a generalization of at least some of the disclosures above and are considered to encompass and/or include various embodiments of the disclosures above (e.g., the various embodiments of the feedback associated with WTRU-specific W2 codebook determination and/or the dynamic subband clustering and LCC values thereof disclosed herein). The flow 600 may be carried out using the architecture of the communications system 100 of FIGS. 1A-1D. The flow 600 may be carried out using other architectures as well.

Referring to FIG. 6, a WTRU may receiving, from a network, configuration information relating to processing of a CSI-RS (602). The WTRU may determine at least one cluster of subbands that have CSI correlation above a first threshold; The WTRU may determine at least one cluster of subbands that have CSI correlation above a first threshold (604). The WTRU may transmit CSI feedback information to the network, wherein the CSI feedback information indicates the at least one cluster of subbands (606). The WTRU may receive, from the network, information indicating a CSI feedback configuration (608). The CSI feedback configuration and/or the information indicating the CSI feedback configuration may be based on the CSI feedback information. The WTRU may determine CSI based on the CSI feedback configuration (610). The WTRU may transmit at least a portion of the CSI to the network (612). In various embodiments, the WTRU may transmit, for example, at least a portion of the CSI to the network based on the CSI feedback configuration.

In various embodiments, the CSI being determined based on the CSI feedback configuration may include the CSI being determined from one or more measurements of the CSI-RS. In various embodiments, the information indicating a CSI feedback configuration may include information indicating to use a CSI feedback configuration.

In various embodiments, the information indicating a CSI feedback configuration may include any of an indication indicating the CSI feedback configuration, an indicator indicating the CSI feedback configuration, an information element indicating the CSI feedback configuration, and a field indicating the CSI feedback configuration.

In various embodiments, the WTRU may transmit a report to the network and the report may include the at least a portion of the CSI.

In various embodiments, the WTRU may receive the information indicating a CSI feedback configuration responsive to the CSI feedback information transmitted to the network.

In various embodiments, the configuration relating to processing of a CSI-RS may include any of a location of CSI-RS in a resource grid, subband size, a CSI correlation threshold, cluster size, feedback size, a duration of CSI-RS measurements over which ab LCC range value may be updated, and scheduling information for feedback of the LCC range value.

In various embodiments, the subbands in the cluster can be non-contiguous.

In various embodiments, the CSI feedback information may include any of locations of the subbands in the cluster, size of the cluster, LCC values per cluster, LCC statistics, and a time-window in which the LCC statistics are predicted to be within a second threshold.

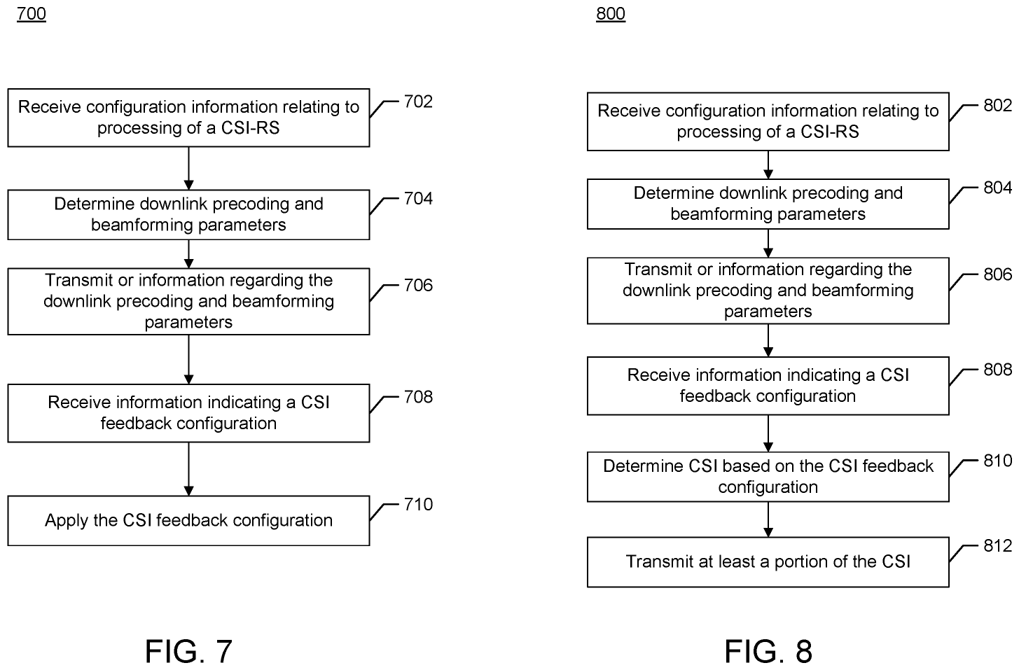

FIG. 7 is a flow chart illustrating an example flow 700 for carrying out WTRU-specific codebook generation and/or providing information associated with the generated WTRU-specific codebook. The flow 700 and accompanying disclosures herein may be considered a generalization of at least some of the disclosures above and are considered to encompass and/or include various embodiments of the disclosures above (e.g., the various embodiments of the WTRU-specific W1 reconfiguration and CSI transmission based on WTRU-specific W1 codebook disclosed herein). The flow 700 may be carried out using the architecture of the communications system 100 of FIGS. 1A-1D. The flow 700 may be carried out using other architectures as well.

Referring to FIG. 7, a WTRU may receive, from a network, configuration information relating to processing of a CSI-RS (702). The WTRU may determine downlink precoding and beamforming parameters (704), e.g., based on the received configuration information. The WTRU may transmit, to the network, feedback and/or information regarding the determined downlink precoding and beamforming parameters (706). The WTRU may receive, from the network, information indicating a CSI feedback configuration (708). The CSI feedback configuration and/or the information indicating the CSI feedback configuration may be based on the feedback and/or information regarding the determined downlink precoding and beamforming parameters. The WTRU may apply the CSI feedback configuration (710), e.g., to determine CSI and transmit at least a portion of the CSI to the network. In various embodiments, the downlink precoding and beamforming parameters may include one or more of precoding vectors and an updated configuration of a precoding codebook.

In various embodiments, the WTRU may transmit at least a portion of the CSI to the network. In various embodiments, the WTRU may transmit, for example, at least a portion of the CSI to the network based on the CSI feedback configuration.

In various embodiments, the CSI being determined based on the CSI feedback configuration may include the CSI being determined from one or more measurements of the CSI-RS. In various embodiments, the information indicating a CSI feedback configuration may include information indicating to use a CSI feedback configuration. In various embodiments, the information indicating a CSI feedback configuration may include any of an indication indicating the CSI feedback configuration, an indicator indicating the CSI feedback configuration, an information element indicating the CSI feedback configuration, and a field indicating the CSI feedback configuration.

In various embodiments, the WTRU may transmit a report to the network and the report may include the at least a portion of the CSI.

In various embodiments, the WTRU may receive the information indicating a CSI feedback configuration responsive to the CSI feedback information transmitted to the network.

In various embodiments, the configuration information received from the network may include any of CSI-RS location in a resource grid, subband features including subband size, a CSI correlation coefficient threshold, a cluster size, feedback size, and a duration of a CSI measurement over which beamforming and precoding vector related parameters may be determined.

FIG. 8 is a flow chart illustrating an example flow 800 for carrying out WTRU-specific codebook generation and/or providing information associated with the generated WTRU-specific codebook. The flow 800 and accompanying disclosures herein may be considered a generalization of at least some of the disclosures above and are considered to encompass and/or include various embodiments of the disclosures above (e.g., the various embodiments of the dynamic subband clustering and LCC values thereof disclosed herein). The flow 800 may be carried out using the architecture of the communications system 100 of FIGS. 1A-1D. The flow 800 may be carried out using other architectures as well.

Referring to FIG. 8, a WTRU may receive, from a network, configuration information relating to processing of a CSI-RS (802). The WTRU may determine downlink precoding and beamforming parameters (804), e.g., based on the received configuration information. The WTRU may transmit, to the network, feedback and/or information regarding the downlink precoding and beamforming parameters (806), The WTRU may receive, from the network, information indicating a CSI feedback configuration (808). The CSI feedback configuration and/or the information indicating the CSI feedback configuration may be based on the feedback and/or information regarding the downlink precoding and beamforming parameters. The WTRU may determine CSI based on the CSI feedback configuration (810). The WTRU may transmit at least a portion of the CSI to the network (812). In various embodiments, the WTRU may transmit, for example, at least a portion of the CSI to the network based on the CSI feedback configuration. In various embodiments, the downlink precoding and beamforming parameters may include one or more of precoding vectors and an updated configuration of a precoding codebook.

In various embodiments, the CSI being determined based on the CSI feedback configuration may include the CSI being determined from one or more measurements of the CSI-RS. In various embodiments, the information indicating a CSI feedback configuration may include information indicating to use a CSI feedback configuration.

In various embodiments, the information indicating a CSI feedback configuration may include any of an indication indicating the CSI feedback configuration, an indicator indicating the CSI feedback configuration, an information element indicating the CSI feedback configuration, and a field indicating the CSI feedback configuration.

In various embodiments, the WTRU may transmit a report to the network and the report may include the at least a portion of the CSI.

In various embodiments, the WTRU may receive the information indicating a CSI feedback configuration responsive to the CSI feedback information transmitted to the network.

In various embodiments, the configuration information received from the network may include any of CSI-RS location in a resource grid, subband features including subband size, a CSI correlation coefficient threshold, a cluster size, feedback size, and a duration of a CSI measurement over which beamforming and precoding vector related parameters may be determined.

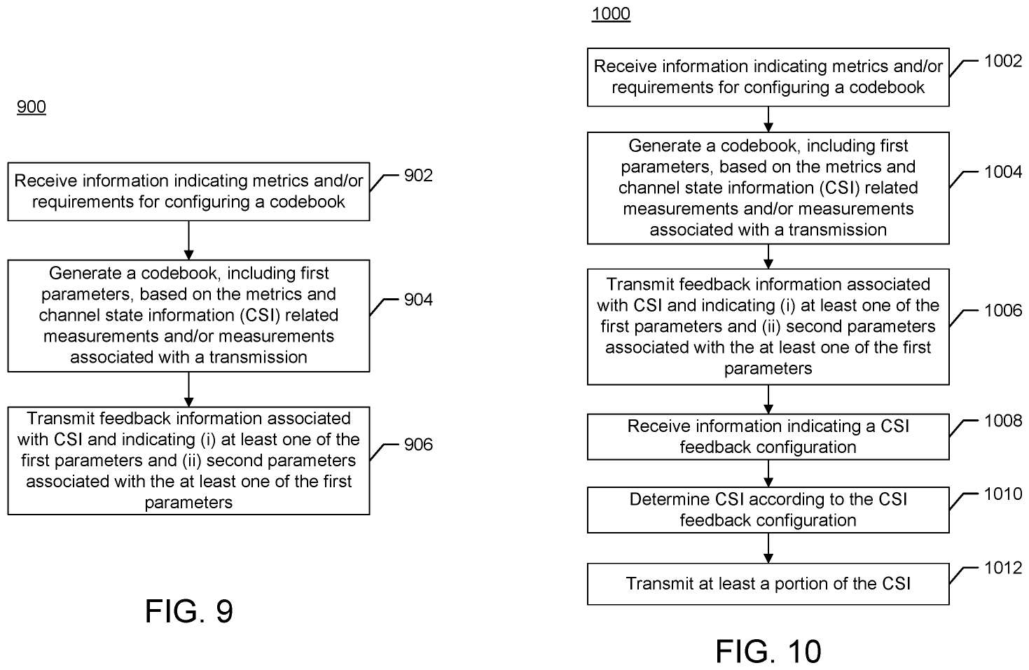

FIG. 9 is a flow chart illustrating an example flow 900 for carrying out WTRU-specific codebook generation and/or providing information associated with the generated WTRU-specific codebook. The flow 900 and accompanying disclosures herein may be considered a generalization of at least some of the disclosures above and are considered to encompass and/or include various embodiments of the disclosures above (e.g., the various embodiments of the LCC value, LCC value range, and/or quantization aspects disclosed herein). The flow 900 may be carried out using the architecture of the communications system 100 of FIGS. 1A-1D. The flow 900 may be carried out using other architectures as well.

Referring to FIG. 9, a WTRU may receive, from a network, information indicating any of one or more metrics and one or more requirements for configuring a codebook (902). The WTRU may generate, form, configure, etc. a codebook, including one or more first parameters, based on the one or more metrics and any of (i) one or more CSI related measurements associated with at least a first set of subbands and (ii) one or more measurements associated with a transmission (904). In various embodiments, the first parameters may include one or more clusters of subbands. Each cluster of subbands may have a CSI correlation satisfying a threshold (e.g., a configured threshold). Each cluster of subbands may include at least one subband from any of the first set of subbands and a second set of subbands. The second set of subbands may be based on the first set of subbands. The WTRU may transmit, to the network, feedback information associated with CSI, wherein the feedback information may indicate (i) at least some of the one or more first parameters and (ii) one or more second parameters associated with the at least some of the one or more first parameters (906).

In various embodiments, the CSI related measurements may include one or more CSI correlation coefficients associated with at least the first set of subbands. In various embodiments, the CSI correlation coefficients may include a CSI correlation coefficient between CSI associated with two subbands. For example, each of the CSI correlation coefficients may be and/or may include a CSI correlation coefficient between CSI associated with two subbands.

In various embodiments, any of the metrics and/or the requirements for configuring a codebook may include a CSI correlation coefficient threshold. In various embodiments, the CSI correlation coefficient threshold may be the threshold.

In various embodiments, any two subbands of (e.g., each cluster of subbands of) the clusters of subbands may have a CSI correlation coefficient that may satisfy the CSI correlation coefficient threshold.

In various embodiments, the WTRU may determine the clusters of subbands (e.g., each cluster of subbands) based on which of the one or more CSI correlation coefficients that may satisfy the CSI correlation coefficient threshold.

In various embodiments, the WTRU may determine the clusters of subbands (e.g., each cluster of subbands), at least in part, by applying the CSI correlation coefficient threshold to the CSI correlation coefficients. In various embodiments, applying the CSI correlation coefficient threshold to the CSI correlation coefficients determines a number of clusters of subbands and a size of each of the clusters of subbands, including a size of the clusters of subbands.

In various embodiments, the CSI related measurements associated with at least a first set of subbands may include one or more estimated channel matrices for at least the first set of subbands. In various embodiments, the WTRU may perform one or more measurements of reference signals associated with at least the first set of subbands, and may estimate one or more channel matrices for at least the first set of subbands based on the one or more measurements.

In various embodiments, the second set of subbands may be derived from the first set of subbands. In various embodiments, the second set of subbands may include some subbands of the first set of subbands.

In various embodiments, any of the metrics and/or the requirements for configuring a codebook may be and/or may include any of one or more CSI correlation coefficients thresholds, an activation command, a trigger to configure the codebook, and a trigger to update to a codebook. In various embodiments, any of the metrics and/or the requirements for configuring a codebook may be and/or include any of a location of reference signal in a resource grid, a subband size, a CSI correlation threshold, a cluster size, a feedback size, a duration of reference signal measurements over which a LCC range value may be updated, and scheduling information for transmitting the LCC coefficient range value.

In various embodiments, the first parameters may be and/or include any of one or more amplitude coefficients, one or more phase coefficients, and co-phasing information. In various embodiments, the second parameters may be and/or may include any of a set of clusters of subbands, sizes of clusters of subbands of the set of clusters of subbands, and resource blocks. In various embodiments, the set of clusters may be and/or include the one or more clusters of subbands.

In various embodiments, the information indicating any of the metrics and/or the requirements for configuring a codebook may be and/or include configuration information.

In various embodiments, the transmission may be and/or may include a target transmission. In various embodiments, the transmission may be and/or include a PDSCH transmission.

In various embodiments, the codebook is generated on a per transmission basis or responsive to a trigger. In various embodiments, the codebook may define a structure based on the one or more first parameters, and the structure and/or the first parameters may change on a per transmission basis or responsive to another trigger.

FIG. 10 is a flow chart illustrating an example flow 1000 for carrying out WTRU-specific codebook generation and/or providing information associated with the generated WTRU-specific codebook. The flow 1000 and accompanying disclosures herein may be considered a generalization of at least some of the disclosures above and are considered to encompass and/or include various embodiments of the disclosures above (e.g., the various embodiments of the LCC value, LCC value range, and/or quantization aspects disclosed herein). The flow 1000 may be carried out using the architecture of the communications system 100 of FIGS. 1A-1D. The flow 1000 may be carried out using other architectures as well.

The flow 1000 of FIG. 10 is similar to the flow 900 of FIG. 9, except as disclosed herein. Referring to FIG. 10, after transmitting the feedback information associated with the CSI, a WTRU may receive, from the network, information indicating a CSI feedback configuration (1008). In various embodiments the CSI feedback configuration may be based on the feedback information. The WTRU may apply the CSI feedback configuration to determine channel state information and transmit at least a portion of the channel state information to the network (not shown). Alternatively, the WTRU may determine CSI (1010) and/or may transmit at least a portion of the CSI to the network (1012). In various embodiments the CSI may be determined based on one or more measurements of reference signals (e.g., CSI-RS). In various embodiments, the WTRU may transmit at least a portion of the CSI to the network based on the CSI feedback configuration. In various embodiments the WTRU may transmit a report to the network, and the report may include the at least a portion of the CSI. In various embodiments the CSI may be determined based on one or more measurements of reference signals (e.g., CSI-RS).

In various embodiments the information indicating a CSI feedback configuration may be and/or may include information indicating to use a CSI feedback configuration. In various embodiments the information indicating a CSI feedback configuration may be and/or include any of an indication indicating the CSI feedback configuration, an indicator indicating the CSI feedback configuration, an information element indicating the CSI feedback configuration, and a field indicating the CSI feedback configuration. In various embodiments the WTRU may receive, from the network, the information indicating a CSI configuration responsive to the CSI feedback information transmitted to the network.

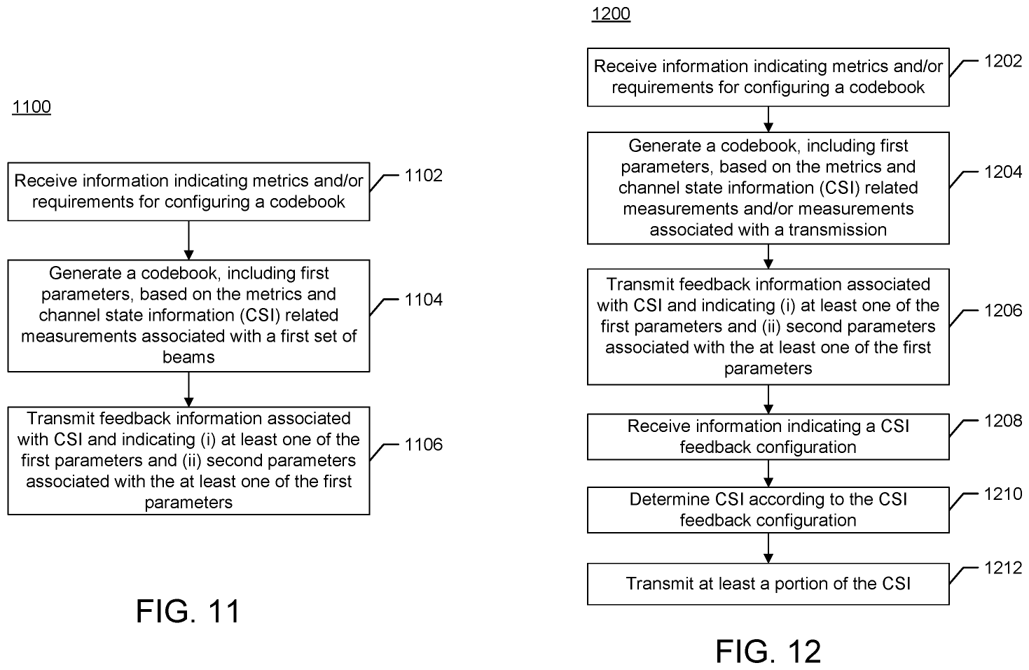

FIG. 11 is a flow chart illustrating an example flow 1100 for carrying out WTRU-specific codebook, e.g., a WTRU-specific W1 codebook, generation and/or providing information associated with the generated WTRU-specific codebook. The flow 1100 and accompanying disclosures herein may be considered a generalization of at least some of the disclosures above and are considered to encompass and/or include various embodiments of the disclosures above (e.g., the various embodiments of the feedback associated with WTRU-specific W1 codebook determination disclosed herein). The flow 1100 may be carried out using the architecture of the communications system 100 of FIGS. 1A-1D. The flow 1100 may be carried out using other architectures as well.

Referring to FIG. 11, a WTRU may receive, from a network, information indicating any of one or more metrics and one or more requirements for configuring a codebook (1102). The WTRU may generate, form, configure, etc. a codebook, including one or more first parameters, based on the one or more metrics and one or more CSI related measurements associated with a set of beams (1104). The WTRU may transmit, to the network, feedback information associated with CSI, wherein the feedback information may indicate (i) at least some of the one or more first parameters and (ii) one or more second parameters associated with the at least some of the one or more first parameters (1106).

In various embodiments, the CSI related measurements associated with the set of beams may include one or more estimated channel matrices for the set of beams. In various embodiments, the WTRU may perform one or more measurements of reference signals (e.g., CSI-RS) associated with the set of beams and may estimate one or more channel matrices for the set of beams based on the one or more measurements.

In various embodiments, the first parameters may be and/or include downlink precoding and beamforming parameters. In various embodiments, the downlink precoding and beamforming parameters may be and/or may include one or more of precoding vectors and an updated configuration of a precoding codebook.

In various embodiments, any of the metrics and/or the requirements for configuring a codebook may be and/or may include an activation command, a trigger to configure the codebook, and a trigger to update to a codebook. In various embodiments, any of the metrics and/or the requirements for configuring a codebook may be and/or include any of a location of reference signal in a resource grid, a feedback size, and a duration of reference signal measurements.

In various embodiments, the first parameters may be and/or include any of one or more amplitude coefficients, one or more phase coefficients, and co-phasing information. In various embodiments, the information indicating any of the metrics and/or the requirements for configuring a codebook may be and/or include configuration information.

In various embodiments, the codebook is generated on a per transmission basis or responsive to a trigger. In various embodiments, the codebook may define a structure based on the one or more first parameters, and the structure and/or the first parameters may change on a per transmission basis or responsive to another trigger.

FIG. 12 is a flow chart illustrating an example flow 1200 for carrying out WTRU-specific codebook, e.g., a WTRU-specific W1 codebook, generation and/or providing information associated with the generated WTRU-specific codebook. The flow 1200 and accompanying disclosures herein may be considered a generalization of at least some of the disclosures above and are considered to encompass and/or include various embodiments of the disclosures above (e.g., the various embodiments of the feedback associated with WTRU-specific W1 codebook determination disclosed herein). The flow 1200 may be carried out using the architecture of the communications system 100 of FIGS. 1A-1D. The flow 1200 may be carried out using other architectures as well.

The flow 1200 of FIG. 12 is similar to the flow 1100 of FIG. 11, except as disclosed herein. Referring to FIG. 12, after transmitting the feedback information associated with the CSI, a WTRU may receive, from the network, information indicating a CSI feedback configuration (1208). In various embodiments the CSI feedback configuration may be based on the feedback information. The WTRU may apply the CSI feedback configuration to determine channel state information and transmit at least a portion of the channel state information to the network (not shown). Alternatively, the WTRU may determine CSI (1210) and/or may transmit at least a portion of the CSI to the network (1212). In various embodiments, the WTRU may transmit at least a portion of the CSI to the network based on the channel state information feedback configuration. In various embodiments the CSI may be determined based on one or more measurements of reference signals (e.g., CSI-RS).

In various embodiments the information indicating a CSI feedback configuration may be and/or may include information indicating to use a CSI feedback configuration. In various embodiments the information indicating a CSI feedback configuration may be and/or include any of an indication indicating the CSI feedback configuration, an indicator indicating the CSI feedback configuration, an information element indicating the CSI feedback configuration, and a field indicating the CSI feedback configuration.

In various embodiments the WTRU may transmit a report to the network, and the report may include the at least a portion of the CSI. In various embodiments the WTRU may receive, from the network, information indicating a CSI configuration responsive to the CSI feedback information transmitted to the network.

Incorporated herein by reference are:
[1]3GPP TS 38.211 V 16.3.0
[2]3GPP TS 38.214 V 16.3.0
[3][R1-1612661]: https://www.3gpp.org/ftp/tsg_ran/WG1_RL1/TSGR1_87/Docs/R1-1612661.zip

### CONCLUSION

Although the solutions described herein consider New Radio (NR), 5G, or LTE, LTE-A specific, tera bit or tera Hz communication protocols, it is understood that the solutions described herein are not restricted to this scenario and are applicable to other wireless systems as well.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a software defined radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a near field communication (NFC) module, a liquid crystal display (LCD) display unit, an organic light-emitting diode (OLED) display unit, a digital music player, a media player, a video game player module, an Internet browser, and/or any wireless local area network (WLAN) or ultra wide band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method comprising:
receiving, from a network, information indicating any of one or more metrics and one or more requirements for generating a codebook;
generating the codebook, comprising one or more first parameters, based on the one or more metrics and any of (i) one or more channel state information related measurements associated with at least a first set of subbands and (ii) one or more measurements associated with a transmission, wherein the one or more first parameters comprise at least one cluster of subbands having a channel state information correlation satisfying a threshold and comprising at least one subband from any of the first set of subbands and a second set of subbands that is based on the first set of subbands; and
transmitting, to the network, feedback information comprising the codebook, wherein the codebook comprises (i) at least some of the one or more first parameters and (ii) one or more second parameters associated with the at least some of the one or more first parameters.

2. (canceled)

3. The method of claim 1, wherein the one or more channel state information related measurements comprise one or more channel state information correlation coefficients associated with at least the first set of subbands.

4. The method of claim 3, wherein the one or more channel state information correlation coefficients comprise a channel state information correlation coefficient between channel state information associated with two subbands.

5. The method of claim 1, wherein any of the one or more metrics and the one or more requirements for generating a codebook comprises a channel state information correlation coefficient threshold, and wherein the threshold comprises the channel state information correlation coefficient threshold.

6. The method of claim 5, wherein any two subbands of the at least one cluster of subbands have a channel state information correlation coefficient satisfying the channel state information correlation coefficient threshold.

7. The method of claim 5, comprising:
determining the at least one cluster of subbands based on which of the one or more channel state information correlation coefficients satisfy the channel state information correlation coefficient threshold.

8. The method of claim 5, wherein:
determining the at least one cluster of subbands comprises applying the channel state information correlation coefficient threshold to the one or more channel state information correlation coefficients, and
applying the channel state information correlation coefficient threshold to the one or more channel state information correlation coefficients determines a number of clusters of subbands and a size of each of the clusters of subbands, including a size of the at least one cluster of subbands.

9. (canceled)

10. (canceled)

11. The method of claim 1, wherein one or more channel state information related measurements associated with at least a first set of subbands comprises one or more estimated channel matrices for at least the first set of subbands.

12. The method of claim 1, comprising:
performing one or more measurements of reference signals associated with at least the first set of subbands; and
estimating one or more channel matrices for at least the first set of subbands based on the one or more measurements.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A wireless transmit/receive unit (WTRU) comprising circuitry, including a transmitter, a receiver, a processor and memory, configured to:
receive, from a network, information indicating any of one or more metrics and one or more requirements for generating a codebook;
generate the codebook, comprising one or more first parameters, based on the one or more metrics and any of (i) one or more channel state information related measurements associated with at least a first set of subbands and (ii) one or more measurements associated with a transmission, wherein the one or more first parameters comprise at least one cluster of subbands having a channel state information correlation satisfying a threshold and comprising at least one subband from any of the first set of subbands and a second set of subbands that is based on the first set of subbands; and
transmit, to the network, feedback information comprising the codebook, wherein the codebook comprises (i) at least some of the one or more first parameters and (ii) one or more second parameters associated with the at least some of the one or more first parameters.

32. The WTRU of claim 31, wherein the one or more channel state information related measurements comprise one or more channel state information correlation coefficients associated with at least the first set of subbands.

33. The WTRU of claim 32, wherein the one or more channel state information correlation coefficients comprise a channel state information correlation coefficient between channel state information associated with two subbands.

34. The WTRU of claim 31, wherein any of the one or more metrics and the one or more requirements for generating a codebook comprises a channel state information correlation coefficient threshold, and wherein the threshold comprises the channel state information correlation coefficient threshold.

35. The WTRU of claim 34, wherein any two subbands of the at least one cluster of subbands have a channel state information correlation coefficient satisfying the channel state information correlation coefficient threshold.

36. The WTRU of claim 34, wherein the circuitry is configured to:
determine the at least one cluster of subbands based on which of the one or more channel state information correlation coefficients satisfy the channel state information correlation coefficient threshold.

37. The WTRU of claim 34, wherein:
the circuitry being configured to determine the at least one cluster of subbands comprises the circuitry being configured to apply the channel state information correlation coefficient threshold to the one or more channel state information correlation coefficients, and
the circuitry being configured to apply the channel state information correlation coefficient threshold to the one or more channel state information correlation coefficients determines a number of clusters of subbands and a size of each of the clusters of subbands, including a size of the at least one cluster of subbands.

38. The WTRU of claim 31, wherein one or more channel state information related measurements associated with at least a first set of subbands comprises one or more estimated channel matrices for at least the first set of subbands.

39. The WTRU of claim 31, wherein the circuitry is configured to:
perform one or more measurements of reference signals associated with at least the first set of subbands; and
estimate one or more channel matrices for at least the first set of subbands based on the one or more measurements.

40. The WTRU of claim 31, wherein the second set of subbands that is based on the first set of subbands comprises any of (i) the second set of subbands being derived from the first set of subbands and (ii) the second set of subbands comprising some subbands of the first set of subbands.

41. The WTRU of claim 31, wherein any of the one or more metrics and the one or more requirements for generating a codebook comprises any of one or more channel state information correlation coefficients thresholds, an activation command, a trigger to configure the codebook, and a trigger to update a codebook.
